(19) United States
(12) Patent Application Publication
(10) Pub. No.: US 2017/0255838 A1
(43) Pub. Date: Sep. 7, 2017

(54) INFORMATION PROCESSING APPARATUS, CONTROL METHOD, AND STORAGE MEDIUM

(71) Applicant: NEC Corporation, Tokyo (JP)

(72) Inventors: Shin NORIEDA, Tokyo (JP); Makoto YOSHIMOTO, Tokyo (JP); Yoshinori SAIDA, Tokyo (JP); Hiroki KOSUGE, Tokyo (JP)

(73) Assignee: NEC Corporation, Tokyo (JP)

(21) Appl. No.: 15/276,953

(22) Filed: Sep. 27, 2016

(30) Foreign Application Priority Data
Mar. 4, 2016 (JP) 2016-042263

(51) Int. Cl. G06K 9/46; G06T 7/00

(52) U.S. Cl. CPC G06K 9/4671; G06T 7/004; G06T 2207/10004

(57) ABSTRACT

According to an embodiment, an information processing system includes a display device and an information processing apparatus. The information processing apparatus includes a product recognition unit, a display control unit, and an operation recognition unit. The product recognition unit recognizes product. The display control unit acquires product information regarding the product recognized by the product recognition unit. Further, the display control unit displays an operation screen including the acquired product information on a display device. The operation recognition unit recognizes an input operation with respect to the operation screen on the basis of the position or movement of an operation body in a captured image.

### BACKGROUND

Technical Field

The present invention relates to an information processing apparatus, a control method, and a storage medium.

Related Art

Systems for viewing information regarding products have been provided. Japanese Patent No. 5220953 discloses the invention of a product information output apparatus. When a user captures an image of product using a camera provided in the product information output apparatus, the product information output apparatus acquires product information regarding product captured in the image generated by the camera and displays the acquired information on a touch panel. In this manner, the user can view the product information. In addition, the user can ask a question regarding the product that the user is viewing, by operating a touch panel provided in the product information output apparatus or speaking through a microphone provided in the product information output apparatus.

### SUMMARY

If the above-mentioned product information output apparatus is used when viewing product in a store, a user needs to hold the product information output apparatus in his or her hand in order to view product information and ask a question regarding the product. For this reason, at least the user's one hand is occupied, and thus the degree of freedom of the user's action decreases. In addition, it may be difficult to use a method of inputting information regarding product with a microphone in a situation where people are present in the surrounding area.

The invention is contrived in view of such a problem. An object of the invention is to provide a technique for increasing the convenience of a system for performing an input operation related to a viewed product.

In one embodiment, there is provided an information processing apparatus to be coupled with a display device. The apparatus comprising a hardware processor configured to: extract a partial region of a captured image as an object recognition region; recognize an object in the object recognition region; acquire object information regarding the recognized object; control the display device to display an operation screen and the acquired object information; recognize an operation body in the captured image; and recognize an input operation with respect to the operation screen on the basis of at least one of a position and a movement of the operation body.

In another embodiment, there is provided an information processing system comprising an information processing apparatus and a display device to be coupled with the information apparatus. The apparatus comprising a hardware processor configured to: extract a partial region of a captured image as an object recognition region; recognize an object in the object recognition region; acquire object information regarding the recognized object; control the display device to display an operation screen and the acquired object information; recognize an operation body in the captured image; and recognize an input operation with respect to the operation screen on the basis of at least one of a position and a movement of the operation body.

In another embodiment, there is provided a control method to be executed by a computer to be coupled with a display device. The method comprising: extracting a partial region of a captured image as an object recognition region; recognizing an object in the object recognition region; acquiring object information regarding the recognized object; controlling the display device to display an operation screen and the acquired object information; recognizing an operation body in the captured image; and recognizing an input operation with respect to the operation screen on the basis of at least one of a position and a movement of the operation body.

In another embodiment, there is provided a non-transitory computer-readable storage medium storing a program. The program causes a computer, which is to be coupled with a display device, to: extract a partial region of a captured image as an object recognition region; recognize an object in the object recognition region; acquire object information regarding the recognized object; control the display device to display an operation screen and the acquired object information; recognize an operation body in the captured image; and recognize an input operation with respect to the operation screen on the basis of at least one of a position and a movement of the operation body.

According to the invention, there is provided a technique for increasing the convenience of a system for performing an input operation related to a viewed product.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram illustrating an information processing system according to a first embodiment.

FIG. 2 is a conceptual diagram illustrating the information processing system.

FIG. 3 is a diagram illustrating a configuration of a computer for realizing the information processing apparatus.

FIG. 4 is a diagram illustrating a head mount display provided in a camera.

FIG. 5 is a flow chart illustrating a flow of processing executed by the information processing apparatus according to the first embodiment.

FIG. 6 is a diagram illustrating product included in a predetermined region of a captured image.

FIGS. 7A and 7B are diagrams illustrating a display device on which a guide indicating a predetermined region is displayed.

FIG. 8 is a diagram illustrating product information in a table format.

FIG. 9 is a diagram illustrating a template of an operation screen.

FIG. 10 is a first diagram illustrating a method of determining the position of an operation body.

FIG. 11 is a second diagram illustrating a method of determining the position of an operation body.

FIG. 12 is a diagram illustrating a captured image on which a user's finger is captured in a blurred state.

FIGS. 13A and 13B are diagrams illustrating an operation determined on the basis of the position of an operation body.

FIGS. 14A and 14B are diagrams illustrating a case where an input operation of inputting a shape determined by the movement of an operation body is recognized.

FIGS. 15A and 15B are diagrams illustrating a gesture input.

FIGS. 16A and 16B are diagrams illustrating that the position and movement of an operation body are indicated by a relative position and movement in the entire captured image.

FIG. 17 is a block diagram illustrating an information processing system according to a second embodiment.

FIG. 18 is a flow chart illustrating a flow of processing executed by a product recognition unit according to the second embodiment.

FIG. 19 is a diagram illustrating a device on which an image handled as a first marker is displayed.

FIG. 20 is a first diagram illustrating a product recognition region.

FIG. 21 is a second diagram illustrating a product recognition region.

FIG. 22 is a third diagram illustrating a product recognition region.

FIG. 23 is a fourth diagram illustrating a product recognition region.

FIG. 24 is a diagram illustrating that the posture of a product recognition region changes in accordance with the inclination of a first marker.

FIG. 25 is a diagram illustrating a region including a hand.

FIG. 26 is a block diagram illustrating an information processing system according to a third embodiment.

FIG. 27 is a flow chart illustrating a flow of processing executed by the information processing apparatus according to the third embodiment.

FIG. 28 is a first diagram illustrating an operation screen the position of which is determined in accordance with the position of a second marker.

FIG. 29 is a second diagram illustrating an operation screen the position of which is determined in accordance with the position of the second marker.

FIG. 30 is a third diagram illustrating an operation screen the position of which is determined in accordance with the position of the second marker.

FIG. 31 is a fourth diagram illustrating an operation screen of which the position is determined in accordance with the position of the second marker.

FIG. 32 is a block diagram illustrating an information processing system according to a fourth embodiment.

FIG. 33 is a flow chart illustrating a flow of processing executed by the information processing apparatus according to the fourth embodiment.

FIG. 34 is a diagram illustrating that an image displayed on a display unit of a device is changed when a sensor detects vibration.

FIGS. 35A to 35C are diagrams illustrating a case where a detection target timing is set as a point in time when a detection target time starts.

FIGS. 36A to 36C are diagrams illustrating a case where a detection target timing is set as a start point in time of a detection target period.

FIG. 37 is a block diagram illustrating a configuration of an information processing system that is common to examples.

FIG. 38 is a diagram illustrating a usage environment of the information processing system that is common to examples.

FIG. 39 is a diagram illustrating an operation screen that is displayed on a display unit in a first example.

FIG. 40 is a diagram illustrating order information in a table format.

FIG. 41 is a diagram illustrating a configuration of a concierge system that provides a concierge service of a second example.

FIG. 42 is a diagram illustrating that a head mount display is used in a third example.

FIG. 43 is a diagram illustrating a map of a store that is displayed on a display unit.

FIGS. 44A and 44B are diagrams illustrating an operation screen that is displayed on a display unit in a fourth example.

FIG. 45 is a diagram illustrating a display unit on which an operation screen for getting in touch with a person in charge of a counter is displayed.

FIG. 46 is a diagram illustrating information displayed on a display unit in a fifth example.

### DETAILED DESCRIPTION

The invention will now be described herein with reference to illustrative embodiments. Those skilled in the art will recognize that many alternative embodiments can be accomplished using the teachings of the present invention and that the invention is not limited to the embodiments illustrated for explanatory purposes.

Hereinafter, embodiments of the invention will be described with reference to the accompanying drawings. In all the drawings, like reference numerals denote like components, and a description thereof will not be repeated. In addition, each block in each block diagram indicates a function-based configuration instead of a hardware-based configuration insofar as there is no particular description.

### First Embodiment

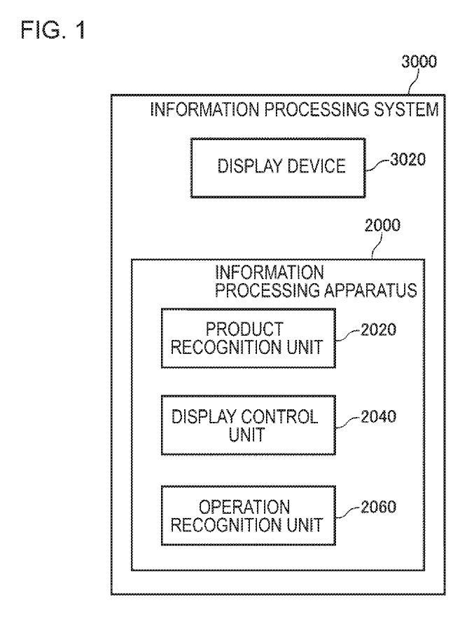

FIG. 1 is a block diagram illustrating an information processing system 3000 according to a first embodiment. The information processing system 3000 includes a display device 3020 and an information processing apparatus 2000. The information processing apparatus 2000 includes a product recognition unit 2020, a display control unit 2040, and an operation recognition unit 2060.

The product recognition unit 2020 recognizes product. The display control unit 2040 acquires product information regarding the product recognized by the product recognition unit 2020. Further, the display control unit 2040 displays an operation screen including the acquired product information on a display device 3020. The operation recognition unit 2060 recognizes an input operation for an operation screen on the basis of the position or movement of an operation body included in a captured image generated by a camera. Here, the operation body is an arbitrary body that is used for a user's operation. For example, the operation body is a portion of a user's body (finger or the like) or a body that is held by a user's body (pen or the like).

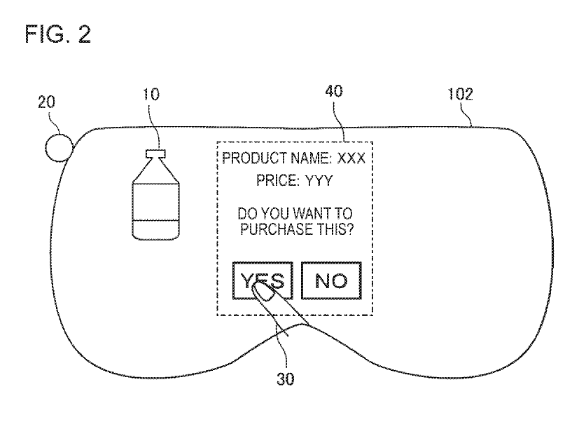

FIG. 2 is a conceptual diagram illustrating the information processing system 3000. In FIG. 2, a user is wearing a head mount display 100. A camera 20 is a camera that generates a captured image and is provided in the head mount display 100. In addition, the camera 20 is provided so as to capture a direction of a user's field of view. In FIG. 2, the display device 3020 is a display unit 102, which is provided in the head mount display 100.

The product recognition unit 2020 recognizes product 10. As a result, the display control unit 2040 displays an operation screen 40 on the display unit 102. The operation screen 40 includes product information regarding the product 10. The product information in this example includes a product name and the price of the product 10. Further, the operation screen 40 includes an image for selecting whether or not to purchase product.

In FIG. 2, an operation body is a user's finger 30. The user holds the finger 30 at a position overlapping an image of YES. Here, in this example, since the camera 20 captures a scene in a direction of the user's field of view, the finger 30 is included in the captured image generated by the camera 20. The operation recognition unit 2060 recognizes an input operation of selecting YES on the basis of the position of the finger 30 that included in the captured image. Thereby, the product 10 is registered as a target to be purchased.

Here, the operation of the information processing apparatus 2000 described with reference to FIG. 2 is an illustrative example for facilitating the understanding of the information processing apparatus 2000, and the operation of the information processing apparatus 2000 is not limited to the above-described example. Details and variations of the operation of the information processing apparatus 2000 will be described below.

### <Advantageous Effects>

According to the information processing system 3000 of this embodiment, an operation screen 40 including product information regarding a recognized product is displayed on the display device 3020. Further, an input operation for the operation screen 40 is recognized on the basis of the position or movement of an operation body that is included in a captured image generated by the camera 20. A user can perform an input operation related to the product by moving or stopping the operation body within an imaging range of the camera 20. Accordingly, the user does not need to hold an input device in his or her hand, unlike a case where an input operation has to be performed using an input device such as a touch panel.

Accordingly, the degree of freedom of the user's operation is increased when performing an input operation related to a viewed product. In addition, the user can easily perform the input operation. Thus, the information processing system 3000 has high convenience for a user, as compared to a system that receives an input operation through an input device.

Hereinafter, the information processing system 3000 of this embodiment will be described in more detail.

### <Example of Hardware Configuration of Information Processing Apparatus 2000>

Each functional configuration unit of the information processing apparatus 2000 may be realized by hardware that realizes each functional configuration unit (for example, a hard-wired electronic circuit or the like), or may be realized by a combination of hardware and software (for example, a combination of an electronic circuit and a program for controlling the electronic circuit, or the like). Hereinafter, a case where each functional configuration unit of the information processing apparatus 2000 is realized by a combination of hardware and software will be further described.

A computer 1000 is any of various computers. For example, the computer 1000 is a head mount display, a personal computer (PC), a server machine, a tablet terminal, a smart phone, or the like. The computer 1000 may be a dedicated computer that is designed to realize the information processing apparatus 2000 or may be a general-purpose computer.

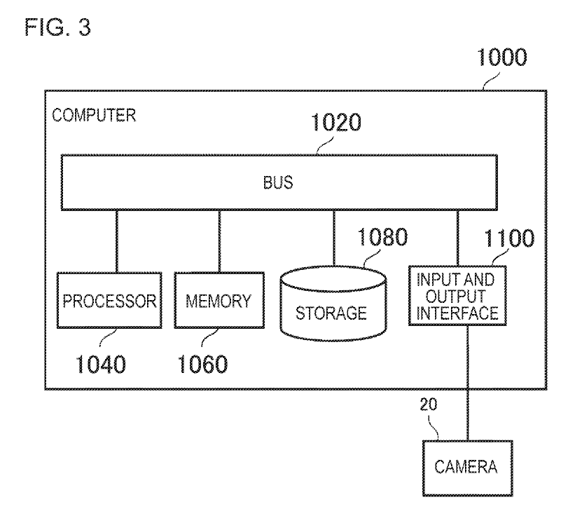

FIG. 3 is a diagram illustrating a configuration of the computer 1000 for realizing the information processing apparatus 2000. The computer 1000 includes a bus 1020, a processor 1040, a memory 1060, a storage 1080, and an input and output interface 1100. The bus 1020 is a data transmission path through which the processor 1040, the memory 1060, and the storage 1080 transmit and receive data to and from each other. However, a method of connecting the processor 1040 and the like to each other is not limited to connection through a bus. The processor 1040 is an arithmetic processing apparatus such as a central processing unit (CPU) or a graphics processing unit (GPU). The memory 1060 is a memory such as a random access memory (RAM) or a read only memory (ROM). The storage 1080 is a storage device such as a hard disk, a solid state drive (SSD), or a memory card. In addition, the storage 1080 may be a memory such as a RAM or a ROM.

The input and output interface 1100 is an interface for connecting the computer 1000 and an input and output device to each other. In FIG. 3, the camera 20 and the display device 3020 are connected to the input and output interface 1100. The camera 20 is any camera that repeatedly capturing to generate a captured image showing each capturing result. Note that, the camera 20 may be a two-dimensional (2D) camera or may be a three-dimensional (3D) camera.

The camera 20 is located at any position. For example, the camera 20 is attached to a certain thing that a user wears. The thing worn by the user is, for example, a head mount display, the user's clothes, an employee ID (identifier) card worn around the user's neck, or the like.

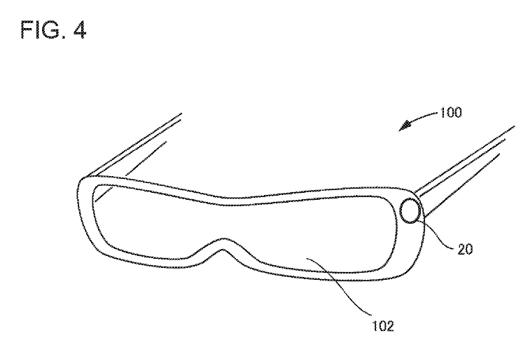

FIG. 4 is a diagram illustrating a head mount display provided with the camera 20. The head mount display 100 is a spectacles-type head mount display. A lens portion of the head mount display 100 functions as a display unit 102. The camera 20 is provided in the vicinity of the display unit 102. In this manner, a scene included in a captured image generated by the camera 20 is the same as a scene in a direction of eyesight of a user who wears the head mount display 100.

The position of the camera 20 is not limited to a thing that the user wears. For example, the camera 20 may be provided on a wall of a room in which the user performs an input operation on the information processing apparatus 2000. In this case, it is preferable that an imaging range (an imaging direction, a zoom rate, or the like) of the camera 20 can be changed by a remote operation using a remote controller or the like.

The display device 3020 is any device that outputs a screen. For example, the display device 3020 is a display unit that displays a screen. For example, the display unit is the display unit 102, which is provided in the head mount display 100 mentioned above. In addition, the display device 3020 may be a device that projects a screen, such as a projector or the like.

The storage 1080 stores program modules that realize the respective functions of the information processing apparatus 2000. The processor 1040 executes the program modules to thereby realize the respective functions corresponding to the program modules.

A hardware configuration of the computer 1000 is not limited to the configuration shown in FIG. 3. For example, each program module may be stored in the memory 1060. In this case, the computer 1000 may not include the storage 1080. In addition, a method of connecting the camera 20 to the computer 1000 is not limited to a connection method through the input and output interface 1100. For example, the camera 20 may be connected to the computer 1000 through a network. In this case, the computer 1000 includes a network interface for connection to a network.

### <Flow of Processing>

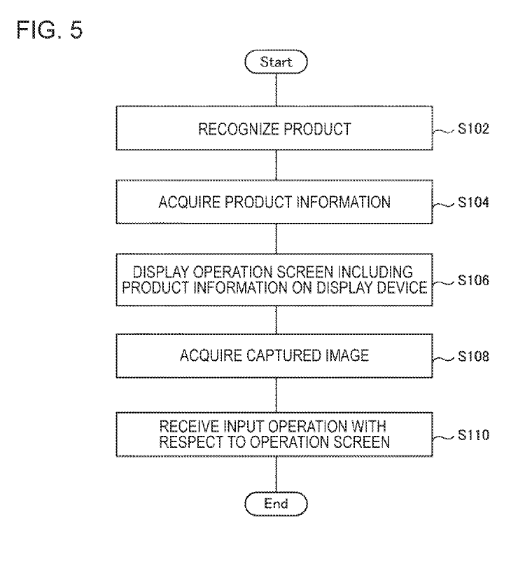

FIG. 5 is a flow chart illustrating a flow of processing that is executed by the information processing apparatus 2000 according to the first embodiment. The product recognition unit 2020 recognizes product (S102). The display control unit 2040 acquires product information regarding the recognized product (S104). The display control unit 2040 displays an operation screen including product information on the display device 3020 (S106). The information processing apparatus 2000 acquires a captured image (S108). The operation recognition unit 2060 recognizes an input operation with respect to the operation screen on the basis of the position or movement of an operation body that is included in the captured image (S110).

Note that, the flow of processing that is executed by the information processing apparatus 2000 is not limited to a flow shown in FIG. 4. For example, the acquisition of the captured image can be performed at any timing before S110. In addition, as described later, when the captured image is used for the display of the operation screen (S106), S108 is performed before S106.

### <Method of Recognizing Product: S102>

The product recognition unit 2020 recognizes product 10 (S102). A method of recognizing the product 10 by the product recognition unit 2020 is arbitrary. Hereinafter, a method of recognizing the product 10 is concretely exemplified.

### <<Method Using Captured Image>>

The product recognition unit 2020 recognizes the product 10 that is included in a captured image generated by the camera 20. More specifically, the product recognition unit 2020 performs object recognition with respect to the captured image to thereby recognize the product 10. Here, various existing techniques can be used for a method of recognizing product that is included in an image.

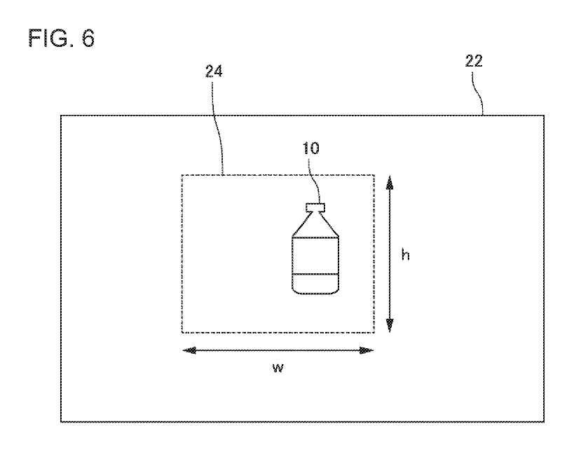

The product recognition unit 2020 may recognize the product 10 with respect to the entire captured image, or may recognize the product 10 with respect to a partial region of the captured image. In the latter case, for example, the product recognition unit 2020 recognizes the product 10 with respect to a predetermined region located at a predetermined position of the captured image. FIG. 6 is a diagram illustrating the product 10 that is included in a predetermined region of a captured image. In FIG. 6, the predetermined region is a predetermined region 24. The predetermined region 24 is a rectangle in which the center position thereof is located at the center of the captured image, the width thereof is a predetermined width w, and the height thereof is a predetermined height h. Note that, information indicating the position of the predetermined region 24 in a captured image 22 and the shape and size of the predetermined region 24 may be set in the product recognition unit 2020 in advance, may be stored in a storage device accessible from the product recognition unit 2020, or may be set by a user.

When the product 10 that is located in the predetermined region 24 included in the captured image is recognized, it is preferable that a guide visually indicating the predetermined region 24 is displayed on the display device 3020. In this manner, the user can easily ascertain how to capture the product 10 in order to make the information processing apparatus 2000 recognize the product 10.

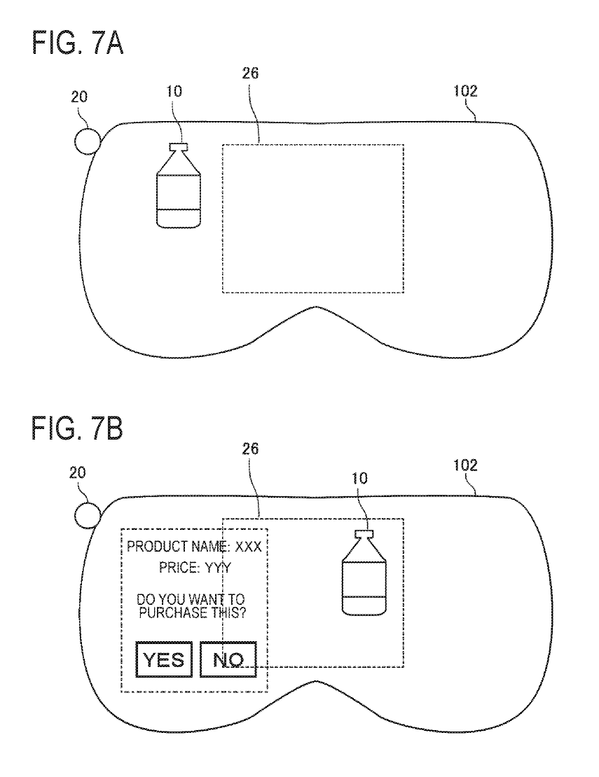

FIGS. 7A and 7B are diagrams illustrating the display device 3020 on which a guide indicating the predetermined region 24 is displayed. In FIGS. 7A and 7B, the display device 3020 is the display unit 102 that is provided in the head mount display 100, and the camera 20 is provided in the head mount display 100. In addition, in FIGS. 7A and 7B, a guide visually indicating the predetermined region 24 is a guide 26.

In FIG. 7A, the product 10 is within a user's eyesight (imaging range of the camera 20) and is located outside the guide 26. Thus, the product 10 is not included in the predetermined region 24 in the captured image 22, and the product 10 is not recognized by the product recognition unit 2020.

On the other hand, in FIG. 7B, the product 10 is located inside the guide 26. Thus, the product 10 is located in the predetermined region 24 in the captured image 22, and the product 10 is recognized by the product recognition unit 2020. As a result, the display control unit 2040 displays an operation screen 40 on the display unit 102.

Note that, a method of recognizing product 10 with respect to a partial region in a captured image is not limited to a method of recognizing product 10 from a predetermined region that is located at a predetermined position. Examples of other methods will be described in embodiments to be described later.

### <<Method Using Tag of Product 10>>

The product recognition unit 2020 acquires an identifier of product (hereinafter, a product ID) that is read from a tag of the product 10 (a tag attached to the product 10 or built into the product 10), and thereby recognizing the product 10. The above-mentioned tag is, for example, a radio frequency identifier (RFID) tag.

The product recognition unit 2020 is communicably connected to any of various readers that read a product ID from the tag of the product 10. A user of the information processing system 3000 operates the reader to read the product ID from the tag of the product 10. The product recognition unit 2020 acquires the product ID from the reader. Note that, the reader may be a stationary reader or may be a portable reader. In the latter case, for example, the user wears and uses a reader that can be worn on his or her hand (wearable).

### <<Method Using Product Information Symbol>>

The product recognition unit 2020 acquires a product ID that is read from a product information symbol attached to product to thereby recognize the product. The product information symbol is a symbol indicating information for identifying product. The term “symbol” as used herein is a bar code, a two-dimensional code (QR Code™ or the like), a character string symbol, or the like. Note that, the term “character string” as used herein may include a numerical string. More specifically, the product information symbol is a bar code in which information including a product ID is encoded, a character string symbol that indicates information including a product ID, or the like.

A method of acquiring a product ID from a product information symbol varies depending on what is used as the product information symbol. When the product information symbol is a bar code, for example, a product ID can be read from the bar code attached to product 10 by using a bar code reader. In this case, the information processing apparatus 2000 is communicably connected to the bar code reader.

When a product information symbol is a two-dimensional code, for example, a product ID can be read from the two-dimensional code that is attached to product 10 by using a two-dimensional code reader. In this case, the information processing apparatus 2000 is communicably connected to the two-dimensional code reader.

When a product information symbol is a character string symbol, for example, a product ID can be acquired by analyzing an image that is included in the character string symbol attached to product 10. Note that, any of various known techniques related to the analysis of a character string can be used for the analysis of a character string symbol.

An image including a character string symbol therein may be the above-described captured image generated by the camera 20, or may be an image generated by any other camera. In the latter case, a process of analyzing a character string symbol may be performed by the product recognition unit 2020, or may be performed by a device other than the information processing apparatus 2000. When a device other than the information processing apparatus 2000 performs the analysis of a character string symbol attached to product 10, the product recognition unit 2020 acquires a product ID of the product 10 from the device that analyzes the character string symbol. In this case, the information processing apparatus 2000 is communicably connected to the device that analyzes the character string symbol that sis attached to the product 10.

When a plurality of types of symbols may be used as product information symbols, the information processing apparatus 2000 is communicably connected to a reader for reading a product ID from each of the plurality of types of symbols, or the like. For example, when a bar code and a two-dimensional code are used as product information symbols, the information processing apparatus 2000 is connected to be able to communicate with a bar code reader and a two-dimensional code reader.

### <Method of Acquiring Product Information: S104>

The display control unit 2040 acquires product information regarding product 10 that is recognized by the product recognition unit 2020 (S104). When the product recognition unit 2020 recognizes the product 10 that is included in a captured image, the display control unit 2040 acquires product information regarding the product 10 using an image of the product 10. For example, the display control unit 2040 acquires product information from a storage device or a database in which a feature-value of the product 10 (information indicating a feature such as the shape, color, or state of the product 10) and the product information regarding the product 10 are stored in association with each other. For example, the display control unit 2040 acquires product information associated with a feature-value the similarity of which to the feature-value of the product 10 extracted from the captured image is equal to or greater than a predetermined value. Information indicating the predetermined value may be set in the display control unit 2040 in advance, or may be stored in a storage device accessible from the display control unit 2040.

On the other hand, when the product recognition unit 2020 acquires a product ID of the product 10 to thereby recognize the product 10, the display control unit 2040 acquires product information associated with the product ID of the product 10 that is recognized by the product recognition unit 2020, from a storage device or a database in which the product ID of the product 10 and the product information regarding the product 10 are stored in association with each other.

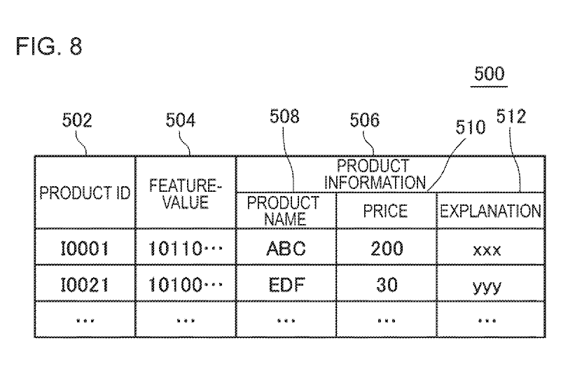

FIG. 8 is a diagram illustrating product information, which is associated with a feature-value and a product ID of the product 10, in a table format. A table shown in FIG. 8 is referred to as a product information table 500. A product ID 502 indicates a product ID of the product 10. A feature-value 504 indicates a feature-value of the product 10. Product information 506 indicates product information regarding the product 10. The product information 506 includes a product name 508, a price 510, and an explanation 512. The product name 508 indicates a name of product. The price 510 indicates a price of product. The explanation 512 is information indicating how to use product, a feature of the product, or the like. Note that, information included in the product information 506 is arbitrary, and is not limited to information shown in FIG. 8.

Note that, a storage device or a database that stores product information may be provided inside the information processing apparatus 2000 or may be provided outside the information processing apparatus 2000.

### <Method of Displaying Operation Screen 40: S106>

The display control unit 2040 displays product information on the display device 3020 (S106). To do so, the display control unit 2040 generates an operation screen 40 on the basis of product information regarding the product 10 that is recognized by the product recognition unit 2020.

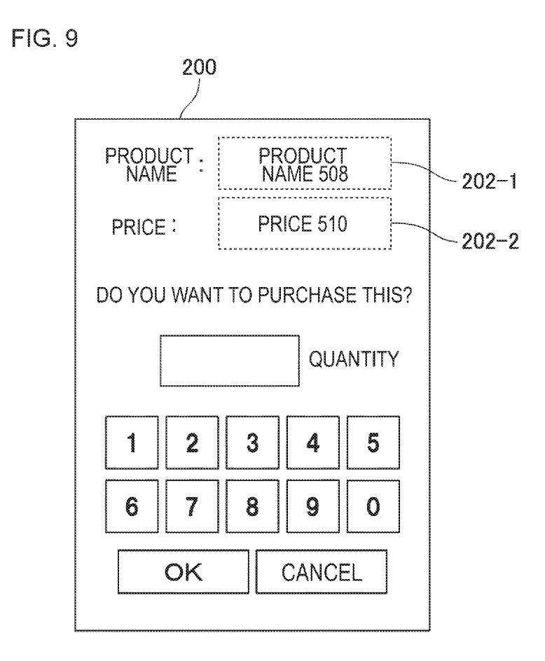

For example, the display control unit 2040 acquires a template of the operation screen 40 and integrates product information into the template in order to generate the operation screen 40. FIG. 9 is a diagram illustrating a template of the operation screen 40. In FIG. 9, the template of the operation screen 40 is a template 200.

The template 200 includes a replacement region 202-1 and a replacement region 202-2. In the template 200, a portion other than the replacement region 202 is a portion that is determined in advance without depending on the recognized product 10. On the other hand, the replacement region 202 is a portion that is determined depending on the recognized product 10.

The display control unit 2040 integrates information included in product information regarding the recognized product 10 into the template, and thereby generating an operation screen 40. In a case of FIG. 9, the display control unit 2040 integrates a product name 508 of a product information table 500 corresponding to the recognized product 10 into the replacement region 202-1. In addition, the display control unit 2040 integrates the price 510 of the product information table 500 corresponding to the recognized product 10 into the replacement region 202-2.

### <Method of Acquiring Captured Image: S108>

The information processing apparatus 2000 acquires a captured image generated by the camera 20 (S108). A method of acquiring a captured image by the information processing apparatus 2000 is arbitrary. For example, the information processing apparatus 2000 acquires a captured image from the camera 20. In this case, the information processing apparatus 2000 and the camera 20 are communicably connected to each other.

In addition, when the camera 20 makes an external storage device store a captured image, the information processing apparatus 2000 may acquire the captured image from the storage device. In this case, the information processing apparatus 2000 is communicably connected to the storage device.

Note that, the information processing apparatus 2000 may acquire all of the captured images generated by the camera 20 or may acquire a part of the captured images. In the latter case, for example, the information processing apparatus 2000 acquires only a captured image that is generated after an operation screen is displayed on the display device 3020. In this case, product recognition performed by the product recognition unit 2020 is not a method in which the product recognition unit 2020 uses a captured image.

### <Regarding Operation Body>

There are various things handled as operation bodies by the operation recognition unit 2060. For example, the operation recognition unit 2060 handles a portion of a user's arm portion (finger or the like) or a thing held by the user's arm portion (pen or the like), as an operation body. In this description, the term “arm portion” as used herein refers to a hand and a portion ranging from the hand to the shoulder. In this case, the user performs an input operation by moving a finger, a pen, or the like within an imaging range of the camera 20.

In addition, for example, the operation recognition unit 2060 may handle a thing or a marker attached to the user's body, as an operation body. The term “marker” as used herein refers to any marker capable of being captured by the camera 20. In this case, the user performs an input operation by moving the marker within the imaging range of the camera 20.

For example, the marker is attached to the user's body (finger or the like). In addition, for example, the marker is attached to a thing held by the user (pen or the like). In addition, for example, the marker is attached to a thing worn by the user. The thing worn by the user is, for example, a ring that is put on the user's finger, any wearable device, or the like.

Information indicating what is handled as an operation body by the operation recognition unit 2060 may be set in the operation recognition unit 2060 in advance, or may be stored in a storage device accessible from the operation recognition unit 2060.

Note that, things handled as an operation body by the operation recognition unit 2060 may be one type or a plurality of types.

### <Method of Detecting Position of Operation Body: S110>

The operation recognition unit 2060 detects the position of an operation body that is included in a captured image in order to recognize an input operation with respect to an operation screen (S108). Here, a known technique can be used as a technique of detecting a predetermined object that is included in an image.

There are various methods with which the operation recognition unit 2060 determines the position of an operation body. For example, the operation recognition unit 2060 determines a region indicating an operation body in a captured image. Then, the operation recognition unit 2060 handles a point included in the determined region as the position of the operation body. At this time, the position of the operation body may be any point included in the region indicating the operation body.

For example, when the operation body is a portion of a user's body or an object held by the user, the operation recognition unit 2060 calculates the centroid of the region indicating the operation body. Then, the operation recognition unit 2060 handles a point that is included in the region indicating the operation body and is farthest from the centroid of the region, as the position of the operation body. According to this method, for example, a fingertip, a pen tip, or the like is determined as the position of the operation body.

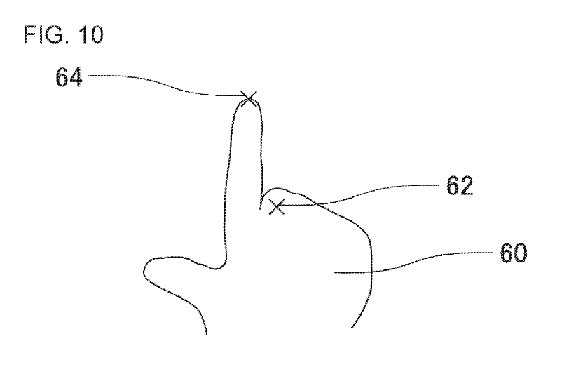

FIG. 10 is a first diagram illustrating a method of determining the position of an operation body. In FIG. 10, the operation body is a user's hand. First, the operation recognition unit 2060 determines a region 60 indicating the user's hand from a captured image. Next, the operation recognition unit 2060 calculates a centroid 62 of the region 60. Then, the operation recognition unit 2060 handles a point 64 being included in the region 60 and being farthest from the centroid 62, as the position of the operation body. Note that, when there are a plurality of points farthest from the centroid 62 in the region 60, for example, the operation recognition unit 2060 handles a point farthest from a first marker 3040 among the plurality of points, as the position of the operation body.

Here, for example, it may also be preferable to handle a location that is slightly shifted from a fingertip as the position of an operation body, like a case where an input operation is performed using the ball of the finger. Thus, the operation recognition unit 2060 may calculate the point 64 farthest from the centroid of the operation body, and may handle a position that is slightly shifted from the point (for example, a position that is slightly shifted by a predetermined distance in a direction approaching the base of the finger), as the position of the operation body. Information indicating a positional relationship between the point 64 being farthest from the centroid of the operation body and the position of the operation body may be set in the operation recognition unit 2060 in advance, may be stored in a storage device accessible from the operation recognition unit 2060, or may be set by the user.

However, the position of the operation body is not limited to a point that is farthest from the centroid 62 or a point that is determined on the basis of the point. For example, the centroid 62 may be treated as the position of the operation body.

When an operation body is a marker attached to a thing or a user's body, for example, the operation recognition unit 2060 determines a region indicating the marker from a captured image and handles a center position of the region or the like as the position of the operation body.

In addition, suppose that the operation recognition unit 2060 detects an operation body using a reference image indicating a thing to be detected as an operation body. In this case, the position of an operation body may be defined in the reference image in advance. The operation recognition unit 2060 determines a region that is similar to the reference image from a captured image. Then, the operation recognition unit 2060 determines a point corresponding to the position of the operation body, which is defined in the reference image, in the region, and handles the point as the position of the operation body.

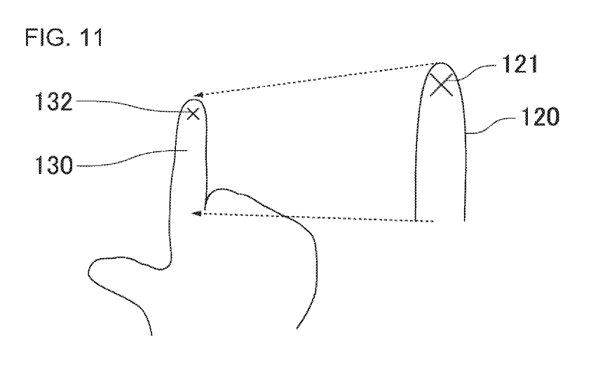

FIG. 11 is a second diagram illustrating a method of determining the position of an operation body. In this example, the operation body is a user's finger. A reference image 120 is a reference image indicating the shape of a user's finger, or the like. A position 121 of the operation body is the position of the operation body that is defined in the reference image in advance.

The operation recognition unit 2060 determines a region 130 similar to the reference image 120 from a captured image 22. The region 130 indicates a user's finger. Further, the operation recognition unit 2060 determines a point 131 corresponding to the position 121 of the operation body when the reference image 120 is mapped to the region 130. Then, the operation recognition unit 2060 handles the point 131 as the position of the operation body.

Information indicating how the operation recognition unit 2060 determines the position of an operation body may be set in the operation recognition unit 2060 in advance, may be stored in a storage device accessible from the operation recognition unit 2060, or may be set by a user.

### <Method of Detecting Movement of Operation Body: S110>

The operation recognition unit 2060 detects the movement of an operation body that is included in the captured image in order to recognize an input operation with respect to the operation screen (S110). The operation recognition unit 2060 may detect the movement of the operation body using a plurality of captured images, or may detect the movement of the operation body using one captured image. In the former case, for example, the operation recognition unit 2060 performs image analysis on each of the plurality of captured images to thereby calculate the position of the operation body in each of the captured images. Then, the operation recognition unit 2060 handles information indicating a change in the position of the operation body, as information indicating the movement of the operation body. Information indicating a change in the position of the operation body is, for example, information that the positions of the operation body are aligned in time series.

As described above, the operation recognition unit 2060 may detect the movement of an operation body using one captured image. A moving operation body may be included in a blurred state in one captured image. Thus, the operation recognition unit 2060 calculates the movement of the operation body from an image of the operation body that is included in a blurred state in one captured image.

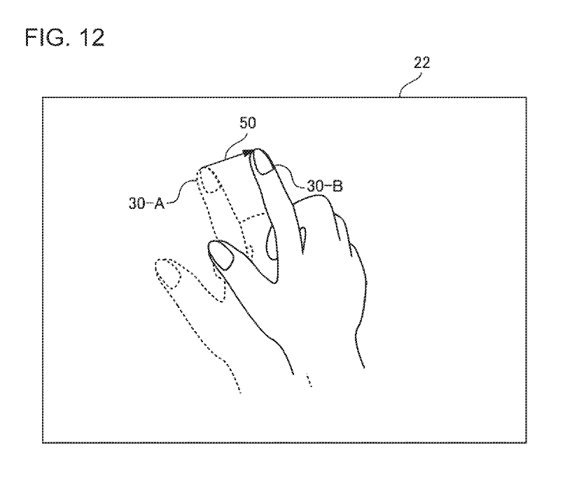

FIG. 12 is a diagram illustrating a captured image 22 in which a user's finger is included in a blurred state. In the captured image 22, a user's finger 30 is included in a blurred state as if a finger 30-A moves to a finger 30-B. The operation recognition unit 2060 detects a change in the position of a feature point that is common to the finger 30-A and the finger 30-B as the movement of an operation body. For example, the operation recognition unit 2060 detects movement 50 that is determined by changes in positions of a fingertip of the finger 30-A and a fingertip of the finger 30-B.

Input Operation Recognized by Operation Recognition Unit 2060: S110

The operation recognition unit 2060 recognizes an input operation with respect to an operation screen on the basis of the position or movement of the detected operation body (S110). The operation recognition unit 2060 can recognize various input operations that are determined on the basis of the position or movement of the operation body. Hereinafter, various input operations that can be recognized by the operation recognition unit 2060 will be described.

### <<Input Operation Determined on the Basis of Position of Operation Body>>

There are various input operations recognized by the operation recognition unit 2060 on the basis of the position of an operation body. For example, the operation recognition unit 2060 receives an input operation of selecting an image indicating a key (hereinafter, a key input operation) on the basis of the position of the operation body.

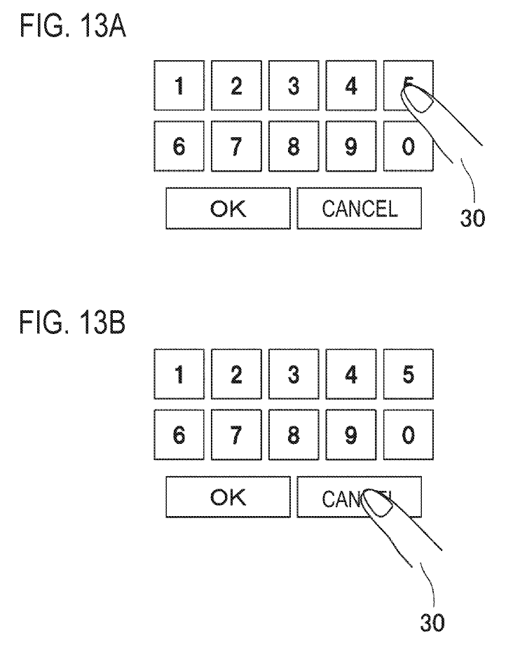

FIGS. 13A and 13B are diagrams illustrating an operation determined on the basis of the position of an operation body. In FIGS. 13A and 13B, the operation body is a finger 30. In FIG. 13A, the finger 30 is positioned on a key of “5”. Thus, the operation recognition unit 2060 recognizes an input operation of inputting “5”. On the other hand, in FIG. 13B, the finger 30 is positioned on a key of “cancel”. Thus, the operation recognition unit 2060 recognizes an input operation of inputting “cancel”.

Note that, the input operation that the operation recognition unit 2060 recognizes on the basis of the position of the operation body may be any input operation that is determined in accordance with the position of the operation body, and is not limited to a key input operation. For example, the operation recognition unit 2060 may recognize an input operation of selecting one of a plurality of photographs displayed on the display device 3020, or the like on the basis of the position of the operation body.

### <<Input Operation Determined on the Basis of Movement of Operation Body>>

The operation recognition unit 2060 may recognize 1) an input operation of inputting a shape based on the movement of the detected operation body, or 2) a predetermined input operation corresponding to the movement of the detected operation body. Hereinafter, each of these cases will be described.

### <<Input Operation of Inputting Shape Based on Movement of Operation Body>>

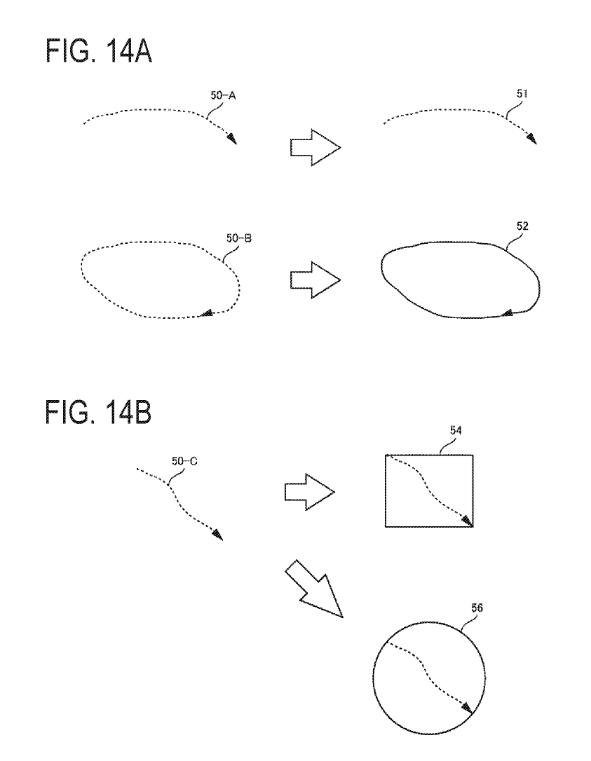

FIGS. 14A and 14B are diagrams illustrating a case where an input operation of inputting a shape determined by the movement of an operation body is recognized. In FIG. 14A, the operation recognition unit 2060 recognizes an input operation of inputting a shape 51 indicated by movement 50-A of an operation body and a shape 52 indicated by movement 50-B thereof. For example, the input operation is used in an input operation of performing a handwriting input.

In FIG. 14B, the operation recognition unit 2060 recognizes an input operation of inputting a shape that is different from the movement of an operation body and has a shape and size determined by the movement of the operation body. Specifically, the operation recognition unit 2060 recognizes an input operation of inputting a rectangle 54 in which both ends of movement 50-C are set as both ends of a diagonal line thereof and inputting a circle 56 in which both ends of the movement 50-C are set as both ends of a diameter thereof. For example, this input is used when a user performs an input indicating a certain range and draws a predetermined figure (selection operation or the like).

Information indicating which of the method shown in FIG. 14A and FIG. 14B is used may be set in the operation recognition unit 2060 in advance, may be stored in a storage device accessible from the operation recognition unit 2060, or may be set by a user.

### <<Predetermined Input Operation Corresponding to Movement of Operation Body>>

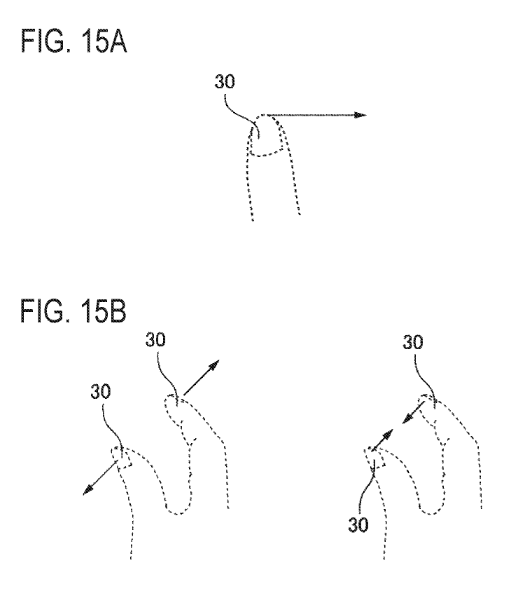

A predetermined input operation corresponding to the movement of the detected operation body is an input operation that is performed, for example, through a gesture input. FIGS. 15A and 15B are diagrams illustrating a gesture input. FIG. 15A shows a flick operation. FIG. 15B shows a pinch-in and pinch-out operation. Note that, an arrow indicates the movement of an operation body.

Information in which the movement of an operation body and a predetermined input operation corresponding to the movement are associated with each other may be set in the operation recognition unit 2060 in advance, may be stored in a storage device accessible from the operation recognition unit 2060 in advance, or may be set by a user.

### <How to Indicate Movement and Position of Operation Body>

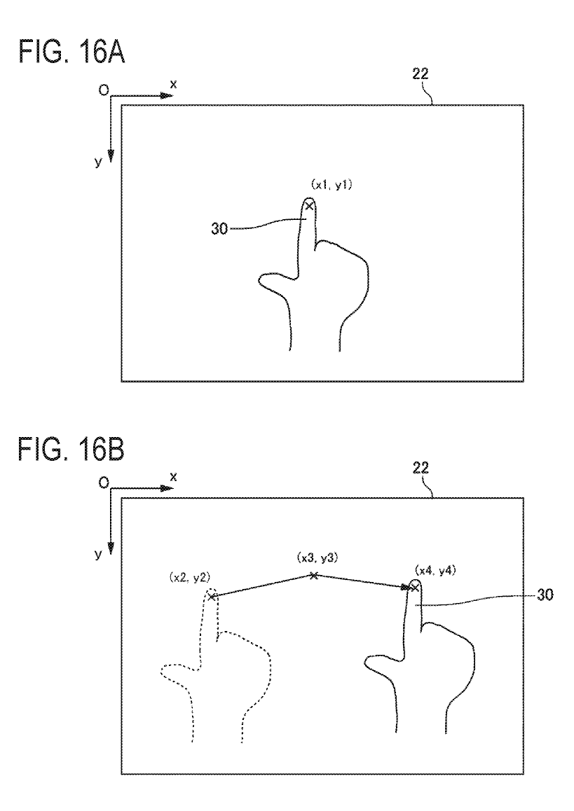

It is arbitrary how the position and movement of an operation body recognized by the operation recognition unit 2060 is indicated. For example, the operation recognition unit 2060 indicates the position and movement of an operation body as a relative position in the entire captured image. FIGS. 16A and 16B are diagrams illustrating that the position and movement of an operation body are indicated by a relative position and movement in the entire captured image. FIG. 16A shows a case where the position of an operation body is recognized as an input operation. In FIG. 16A, the coordinate (x1, y1), which is the position of the operation body, is a coordinate in a coordinate system in which an upper left end of the captured image 22 is set as the origin, the right direction in a plan view of the captured image 22 is set as X-axis, and a downward direction in a plan view of the captured image 22 is set as Y-axis.

FIG. 16B shows a case where the movement of an operation body is recognized as an input operation. An arrow indicates a trajectory of the operation body. In FIG. 16B, the position of the operation body changes in the order of (x2, y2), (x3, y3), and (x4, y4). All of these coordinates are coordinates in the coordinate system described in FIG. 16A. The movement of the operation body is shown by, for example, information in which these coordinates are aligned in time series.

Note that, the above-described method of indicating the position and movement of the operation body is merely an example. A method indicating the position and movement of the operation body may be any method capable of indicating the position and movement of the operation body, and is not limited to the above-described method.

<<Handling of Location where Operation of Moving Operation Body is Performed>>

The operation recognition unit 2060 may perform 1) recognition of an input using only the movement of an operation body as an input regardless of a position where an operation of moving the operation body is performed, or 2) recognition of an input using a combination of the movement of an operation body and a position where an operation of moving the operation body is performed. In the former case, even when the operation of moving the operation body is performed at any location on a captured image, the same movement of the operation body indicates the same input. On the other hand, in the latter case, it is meaningful where an operation of moving the operation body has been performed on a captured image. For example, in a case where a user performs an input of surrounding a specific thing included in the captured image by a circle, not only a shape such as a circle but also what is surrounded by the circle is meaningful.

In the case of 1), for example, the operation recognition unit 2060 recognizes a shape determined by the movement of an operation body that is detected by the operation recognition unit 2060 or a gesture determined by the movement of an operation body, as an input as described above. In addition, for example, the operation recognition unit 2060 may recognize as an input the transition of relative coordinates of the operation body based on a starting point of the movement of the operation body.

On the other hand, in the case of 2), the operation recognition unit 2060 recognizes as an input the transition of coordinates of an operation body on a captured image that is detected by the operation recognition unit 2060. However, even in the case of 1), the operation recognition unit 2060 may recognize as an input the transition of coordinates of the operation body on the captured image as an input, similar to the case of 2).

By which method of 1) and 2) the operation recognition unit 2060 recognizes an input may be set in the operation recognition unit 2060 in advance, may be stored in a storage device accessible from the operation recognition unit 2060, or may be set by a user.

### <<By Which of Position and Movement of Operation Body Input Operation is Recognized>>

The operation recognition unit 2060 recognizes an input operation by the position or movement of an operation body. Here, there are various methods of determining by which of the position and movement of an operation body an input operation is recognized. For example, it is defined in advance by which of the position and movement of an operation body an input operation is recognized. Here, information indicating by which of the position and movement of an operation body an input operation is recognized may be set in the operation recognition unit 2060, may be stored in a storage device accessible from the operation recognition unit 2060, or may be set by a user.

In addition, for example, the operation recognition unit 2060 may determine by which of the position and movement of an operation body an input operation is recognized, in accordance with the degree of movement of the operation body. For example, in a case where the size of the operation body in a movement range within a predetermined time is less than a predetermined value, the operation recognition unit 2060 recognizes an input operation by the position of the operation body. Thereby, for example, the operation recognition unit 2060 recognizes an input operation indicating the position when a user holds the operation body at a certain position. This operation is, for example, an operation having an image such as long pressing performed at a certain location using a mouse.

In this case, the position of the operation body that is recognized as an input operation by the operation recognition unit 2060 is determined in accordance with the position of the operation body within the predetermined time. For example, the operation recognition unit 2060 handles at least one of positions of the operation body within the predetermined time, as the position of the operation body. In addition, for example, the operation recognition unit 2060 handles a statistical value that is calculated from the position of the operation body within the predetermined time (average value, the most frequent value, or the like), as the position of the operation body.

On the other hand, when the size of the operation body in the movement range within the predetermined time is equal to or greater than the predetermined value, the operation recognition unit 2060 recognizes an input operation by the movement of the operation body.

Information indicating the above-mentioned predetermined time or predetermined value may be set in the operation recognition unit 2060, may be stored in a storage device accessible from the operation recognition unit 2060, or may be set by a user.

### Second Embodiment

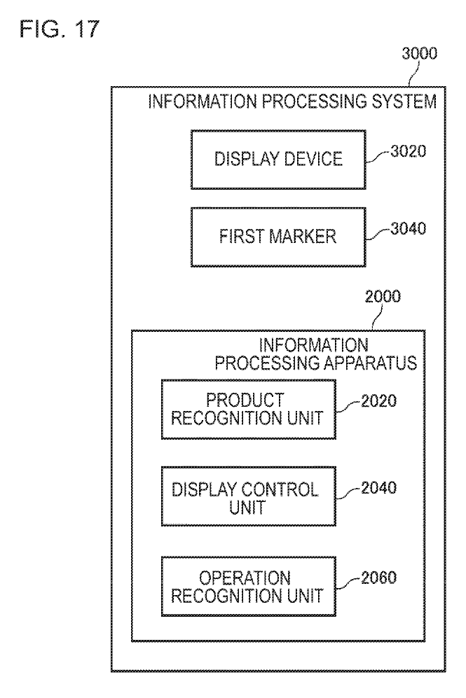

FIG. 17 is a block diagram illustrating an information processing system 3000 according to a second embodiment. The information processing system 3000 of the second embodiment has the same function as that of the information processing system 3000 of the first embodiment except for the following things.

The information processing system 3000 includes a first marker 3040. The first marker 3040 is worn by a user or is a portion of the user's body. The first marker 3040 will be described later in detail.

A product recognition unit 2020 of the second embodiment recognizes product from a captured image generated by a camera 20. At this time, the product recognition unit 2020 recognizes product from a partial region included in the captured image instead of from the entire captured image. The “partial region” is determined by the first marker 3040 included in the captured image.

Specifically, first, the product recognition unit 2020 extracts a product recognition region determined on the basis of the position of the first marker 3040 included in the captured image. Then, the product recognition unit 2020 recognizes product included in the product recognition region.

### <Flow of Processing>

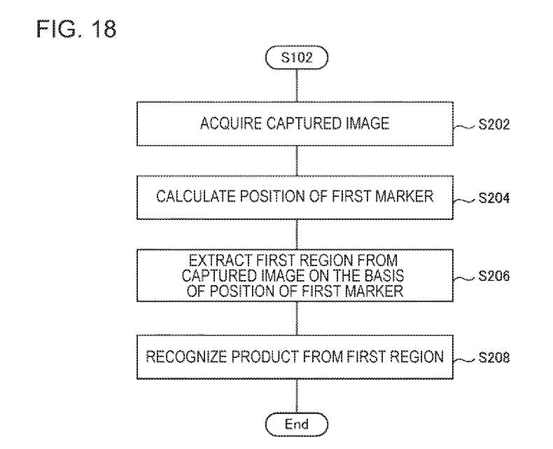

FIG. 18 is a flow chart illustrating a flow of processing executed by the product recognition unit 2020 of the second embodiment. The flow chart shows an example of a sequence of processes performed in S102 of FIG. 4.

The product recognition unit 2020 acquires a captured image (S202). The product recognition unit 2020 calculates the position of the first marker 3040 included in the captured image (S204). The product recognition unit 2020 extracts a product recognition region from the captured image on the basis of the position of the first marker 3040 (S206). The product recognition unit 2020 recognizes product 10 included in the product recognition region (S208).

### <Regarding First Marker 3040>

The first marker 3040 is arbitrary thing at least the position of which can be determined in a captured image that the camera 20 generates. For example, the first marker 3040 is a marker that can be used for the determination of a three-dimensional coordinate system. The marker that can be used for the determination of the three-dimensional coordinate system is, for example, an augmented reality (AR) marker. However, the marker that can be used for the determination of the three-dimensional coordinate system may be not only AR marker, but also anything with which three directions from a certain reference point, which are perpendicular to each other, can be uniformly obtained irrespective of a reference direction. In addition, the first marker 3040 may be anything the position of which can be determined in the captured image, and does not necessarily need to be used for the determination of the three-dimensional coordinate system.

In a case where the first marker 3040 is a marker attached to a user's body, the first marker 3040 may be attached to any location of the user's body. For example, the first marker 3040 is attached to the user's arm portion.

For example, in this case, the first marker 3040 is an image displayed on a display unit of a device attached to a user's arm portion. The device is any electronic device having a function of displaying an image on the display unit. Note that, the device may be directly attached to the user's arm portion, or may be attached to the clothes on the user's arm portion.

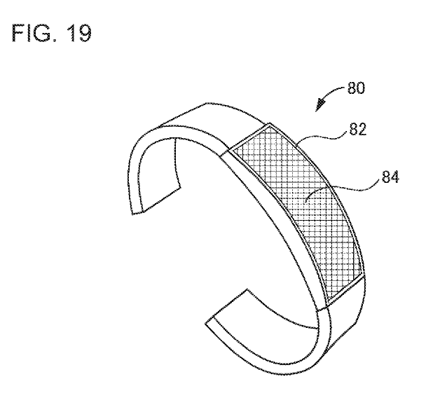

FIG. 19 is a diagram illustrating a device on which an image handled as the first marker 3040 is displayed. In FIG. 19, the first marker 3040 is a marker image 84, which is displayed on a touch panel 82 of a device 80. The marker image 84 may be an image stored in the device 80 in advance, or may be an image stored in a storage device provided outside the device 80. In the latter case, the device 80 acquires the marker image 84 from the storage device and displays the acquired marker image.

The first marker 3040 is not limited to something displayed on a device as described above. For example, the first marker 3040 may be directly drawn on a user's arm portion or the like, or may be drawn on an arbitrary thing located at the user's arm portion or the like. In the latter case, for example, the first marker 3040 is drawn on a ring that the user wear on her or his finger, a wrist band that the user wear on her or his wrist, a sleeve of clothes that the user wear, or the like. Note that, the first marker 3040 may be drawn by a hand or may be printed.

Further, the first marker 3040 may be a light-emitting device that emits light (light-emitting diode (LED) or the like). Note that, in a case where the first marker 3040 is a light emitting device and a three-dimensional coordinate system is determined on the basis of the first marker 3040, the first marker 3040 is constituted using three or more light emitting devices. The product recognition unit 2020 calculates the position of light emitted by each of the three or more light emitting devices included in a captured image. Then, the product recognition unit 2020 can determine the three-dimensional coordinate system on the basis of the positions of the light emitting devices. Note that, a known method can be used for determining a three-dimensional coordinate system using three or more things.

Further, the first marker 3040 may be a specific portion of a user's body. For example, the first marker 3040 is the back of the user's hand, or the like.

In order to detect the first marker 3040 from a captured image, the product recognition unit 2020 uses information for specifying a thing handled as the first marker 3040 (information regarding the shape, size, color, and the like of the first marker 3040: hereinafter, referred to as marker information). The marker information may be set in the product recognition unit 2020 in advance, or may be stored in a storage device accessible from the product recognition unit 2020.

### <Method of Calculating Position of First Marker 3040: S204>

The product recognition unit 2020 analyzes a captured image using marker information to thereby detect the first marker 3040 included in the captured image. In addition, the product recognition unit 2020 calculates the position of the detected first marker 3040. Here, various known techniques can be used for detecting a predetermined thing from an image and calculating the position of the thing in the image. Note that, the position of the first marker 3040 is indicated by, for example, a relative position in the entire captured image (coordinate), similar to the position of an operation body. For example, the position of the first marker 3040 is the coordinate of the center position of the first marker 3040 in the entire captured image. However, the position of the first marker 3040 is not limited to the center position of the first marker 3040.

### <Method of Extracting Product Recognition Region: S206>

The product recognition unit 2020 extracts a product recognition region from a captured image on the basis of a calculated position of the first marker 3040 on a captured image (S106). The product recognition region is any region that is determined on the basis of the position of the first marker 3040. For example, the product recognition region is a region that is determined by a predetermined shape the center position of which is at the center position of the first marker 3040. The predetermined shape is any shape, such as a circular shape or a rectangular shape.

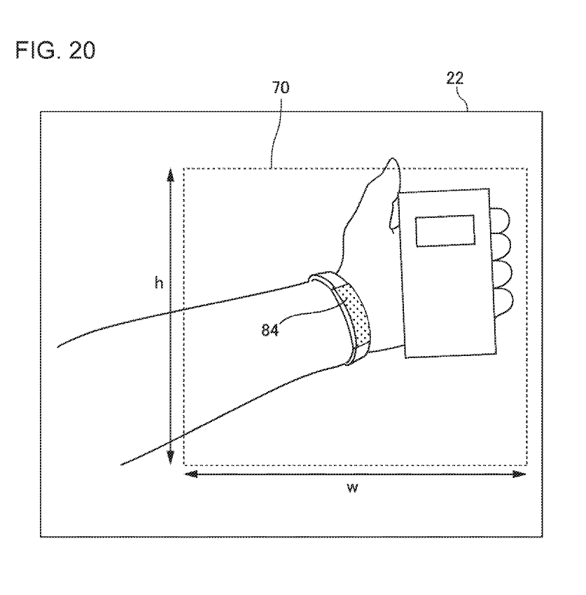

FIG. 20 is a first diagram illustrating a product recognition region 70. In FIG. 20, the product recognition region 70 is a rectangle the center position of which is at the center position of a marker image 84 (first marker 3040), the width of which is a predetermined length w, and the height of which is a predetermined length h.

However, a position which is determined in accordance with the position of the first marker 3040 is not limited to the center position of the product recognition region 70. For example, a position such as an upper left end of the product recognition region 70 may be determined in accordance with the position of the first marker 3040.

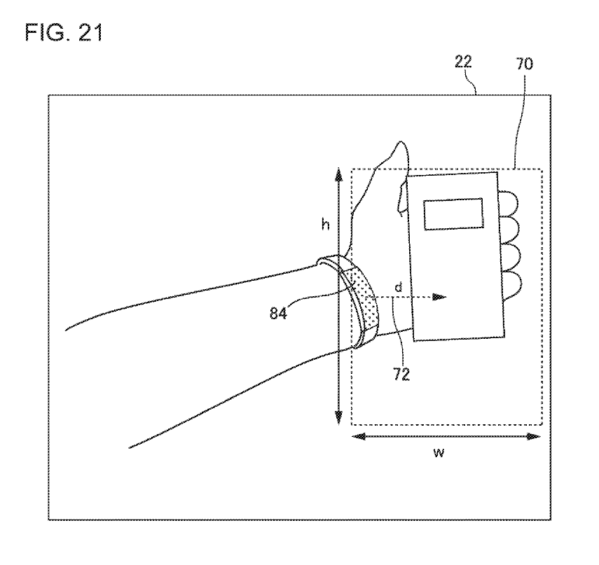

In addition, for example, the product recognition region 70 may be a region of which the center position is positioned at a location separated from the position of the first marker 3040 in a predetermined direction at a predetermined distance. FIG. 21 is a second diagram illustrating the product recognition region 70. In FIG. 21, the center position of the product recognition region 70 is a location shifted from the first marker 3040 in a direction determined by an arrow 72 at a distance d.

Meanwhile, in FIGS. 20 and 21, the product recognition region 70 has a predetermined shape in a plane (xy plane in FIGS. 16A and 16B) which is indicated by a captured image. However, the product recognition region 70 may have a predetermined shape in a plane other than the plane indicated by the captured image.

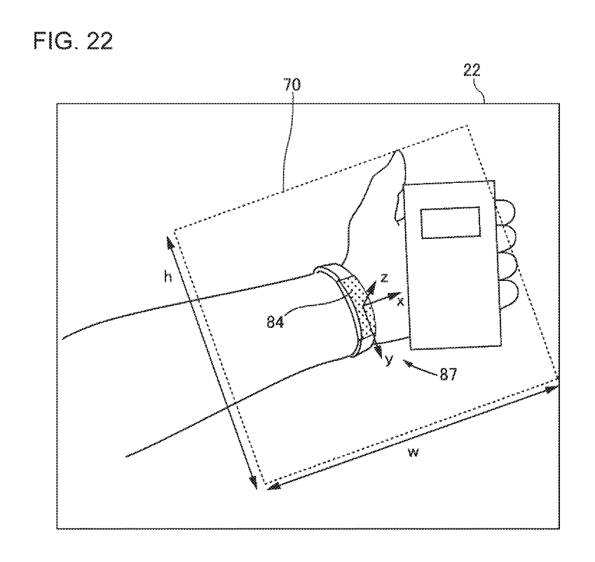

For example, the product recognition region 70 may have a predetermined shape on a plane in a three-dimensional coordinate system which is determined by the first marker 3040. FIG. 22 is a third diagram illustrating the product recognition region 70. The product recognition region 70 of FIG. 22 is a rectangle the center position of which is at the center position of a marker image 84 (first marker 3040), the width of which is a predetermined length w, and the height of which is a predetermined length h, similar to the product recognition region 70 of FIG. 20. However, in FIG. 22, the product recognition region 70 is a rectangle in a xy plane of a coordinate system 87 which is determined by the marker image 84. More specifically, in the product recognition region 70, a starting point of the coordinate system 87 is set as the center position thereof, the length of the coordinate system 87 in the x-axis direction is w, and the length of the coordinate system 87 in the y-axis direction is h.

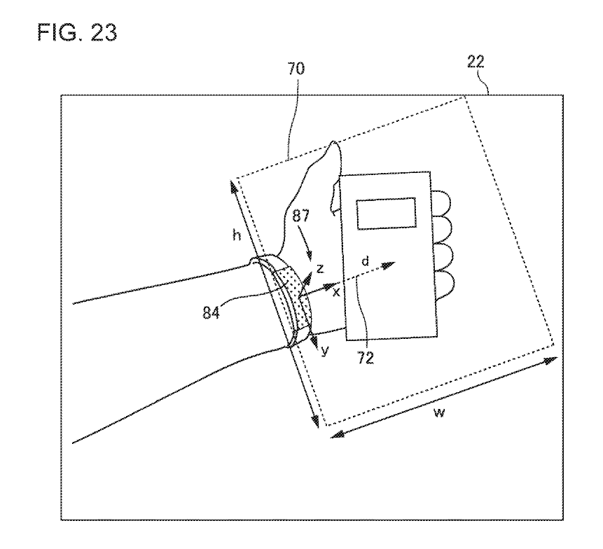

FIG. 23 is a fourth diagram illustrating a product recognition region 70. The product recognition region 70 of FIG. 23 is a rectangle the center position of which is at a location shifted from a marker image 84 in a direction determined by an arrow 72 at a distance d, the width of which is a predetermined length w, and the height of which is a predetermined length h, similar to the product recognition region 70 of FIG. 21. However, in FIG. 23, the direction indicated by the arrow 72 is set as a direction in a coordinate system 87. In addition, in the product recognition region 70, the length of the coordinate system 87 in the x-axis direction is w, and the length of the coordinate system 87 in the y-axis direction is h.

In this manner, the product recognition region 70 is extracted using a coordinate system determined by the first marker 3040, and thus the posture of the product recognition region 70 follows the change of the posture of the first marker 3040. For example, in the example of FIG. 22, when a user twists her or his wrist having a device 80 provided thereon, the posture of the product recognition region 70 changes in accordance with the twist.

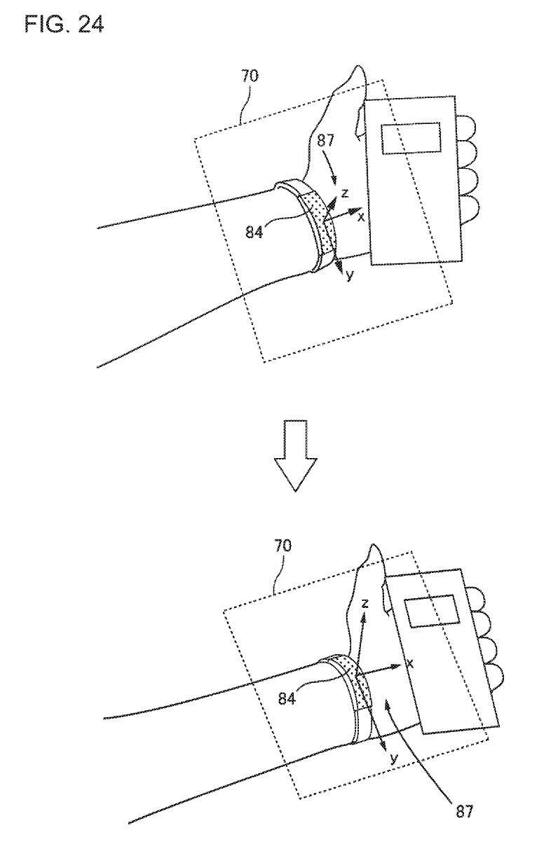

FIG. 24 is a diagram illustrating that the posture of a product recognition region 70 changes in accordance with the inclination of the first marker 3040. In FIG. 24, a user twists her or his wrist, and thus the posture of a marker image 84 (coordinate system 87 determined by the marker image 84) changes. Further, the posture of the product recognition region 70 also changes so as to follow the change.

By making the posture of the product recognition region 70 change in accordance with a change in the posture of the first marker 3040 in the above-described manner, something on the real world that is desired to be included in the product recognition region 70 can be included in the product recognition region 70, irrespective of the posture of the first marker 3040. For example, in the examples of FIGS. 23 and 24, a user's hand is included in the product recognition region 70 by appropriately defining the shape, size, and position of the product recognition region 70, irrespective of the posture of the marker image 84. In this case, the user holds product 10 in her or his hand, and thus can let an information processing apparatus 2000 recognize the product 10. Accordingly, the user easily uses the information processing apparatus 2000.

Note that, information indicating the above-described predetermined shape or information that indicates which location is set as the center of the first marker 3040 (information regarding an arrow 72, or the like) may be set in the product recognition unit 2020 in advance, may be stored in a storage device accessible from the product recognition unit 2020, or may be set by a user.

In addition, when using the coordinate system 87 determined on the basis of the first marker 3040, the first marker 3040 is a marker that can be used for the determination of three-dimensional coordinates (AR marker or the like). Note that, various existing techniques can be used for determining a three-dimensional coordinate system using an AR marker or the like.

In addition, the size of the product recognition region 70 (width w, height h, and the like that are described above) may be defined by an absolute value (the number of pixels or the like), or may be defined by a relative value. In the latter case, for example, the size of the product recognition region 70 is indicated by a relative value with respect to the size of a captured image. The relative value with respect to the size of the captured image is, for example, a relative value with the width or height of the captured image being set to 1. In addition, for example, the size of the product recognition region 70 may be indicated by a relative value with respect to the size of the first marker 3040. The relative value with respect to the size of the first marker 3040 is, for example, a relative value with the width, height, diagonal line, diameter, or the like of the first marker 3040 being set to 1. When the size of the product recognition region 70 is indicated by the relative value with respect to the size of the first marker 3040, the product recognition region 70 becomes larger as the first marker 3040 is located closer to the camera 20, and the product recognition region 70 becomes smaller as the first marker 3040 is located farther from the camera 20.

In addition, the product recognition unit 2020 may extract a predetermined region that is determined using the first marker 3040 as a boundary, as the product recognition region 70. For example, when the device 80 is provided on a user's wrist, the product recognition unit 2020 extracts a region including a hand from regions determined using the marker image 84 (first marker 3040) as a boundary, as the product recognition region 70.

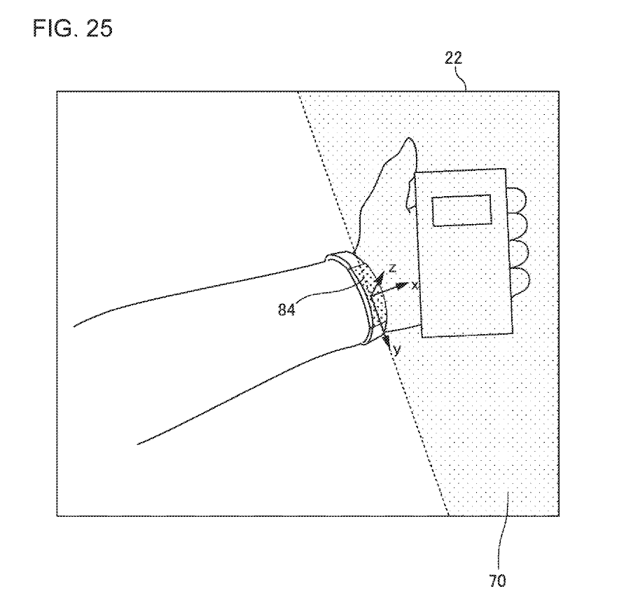

FIG. 25 is a diagram illustrating a region including a hand. In FIG. 25, the product recognition unit 2020 divides a captured image 22 into two regions by using as a boundary a y-axis in the coordinate system 87 that is determined by the marker image 84. In addition, the product recognition unit 2020 extracts a region including a hand (region on the right side in FIG. 25) from the two regions obtained by the division, as the product recognition region 70.

Note that, a positional relationship between an arm and a hand using the first marker 3040 as a boundary (which side is an arm and which side is a hand) varies according to on which arm portion the first marker 3040 is provided. For example, the product recognition unit 2020 recognizes on which arm portion the first marker 3040 is provided, by using information indicating on which arm portion the first marker 3040 is provided. This information may be set in the product recognition unit 2020 in advance, may be stored in a storage device accessible from the product recognition unit 2020, or may be set by a user.

### <Method of Recognizing Product Seen in Product Recognition Region: S208>

The product recognition unit 2020 recognizes product 10 that is included in a product recognition region 70 extracted from a captured image. Here, various known methods can be used for recognizing an object that is included in a specific region of an image through image analysis.

### <Hardware Configuration>

A hardware configuration of a computer that realizes the information processing apparatus 2000 of the second embodiment is shown by, for example, FIG. 3, similar to the first embodiment. However, a program module realizing the function of the information processing apparatus 2000 of this embodiment is further stored in a storage 1080 of a computer 1000 that realizes the information processing apparatus 2000 of this embodiment.

### <Advantageous Effects>

According to this embodiment, a product recognition region 70 that is a partial region of a captured image is extracted, and product 10 is recognized from the product recognition region 70. Thus, the size of data to be a target for image processing becomes smaller than in a case of performing a process of recognizing the product 10 from the entire captured image. A process of recognizing product 10 in this embodiment therefore becomes lighter than a process of recognizing product 10 from the entire captured image, and time and computer resources required for the process are reduced.

In addition, according to this embodiment, since product 10 is recognized from a product recognition region 70 extracted on the basis of the first marker 3040 included in a captured image, the product 10 is not recognized when the first marker 3040 is not included in the captured image, and thus an operation screen 40 is not displayed. Therefore, a user can easily control whether to display the operation screen 40 on a display device 3020 in accordance with whether to include the first marker 3040 in an imaging range of a camera 20.

The user may not necessarily require that the operation screen 40 be displayed at all times. For example, in a case where the display device 3020 is the display unit 102 of the head mount display 100, it is possible that a user desires to display the operation screen 40 only when necessary in order to make the eyesight clear as much as possible. According to the information processing apparatus 2000 of this embodiment, the user can easily control whether to display the operation screen 40 on the display device 3020 in accordance with whether to include the first marker 3040 in the imaging range of the camera 20. More specifically, in a case where the camera 20 is provided in the head mount display 100, the user can make the operation screen 40 displayed by including the first marker 3040 within the eyesight and can make the operation screen 40 not displayed by not including the first marker 3040 within the eyesight. Since the operation screen 40 can be displayed only when necessary through such an easy operation, user convenience of the information processing system 3000 is improved.

In addition, since a user's input operation is performed when the operation screen 40 is displayed, it can be understood that the user has no intention of performing an input operation when the operation screen 40 is not displayed, that is, when the first marker 3040 is not included in a captured image. According to the information processing apparatus 2000 of this embodiment, product 10 is not recognized when the first marker 3040 is not included in a captured image, and thus the operation screen 40 is not displayed. Therefore, an operation recognition unit 2060 does not also recognize an input operation. In this manner, since the operation recognition unit 2060 does not recognize an input operation when the user has no intention of performing an input operation, it is possible to prevent computer resources of the information processing apparatus 2000 from being wasted.

### Third Embodiment

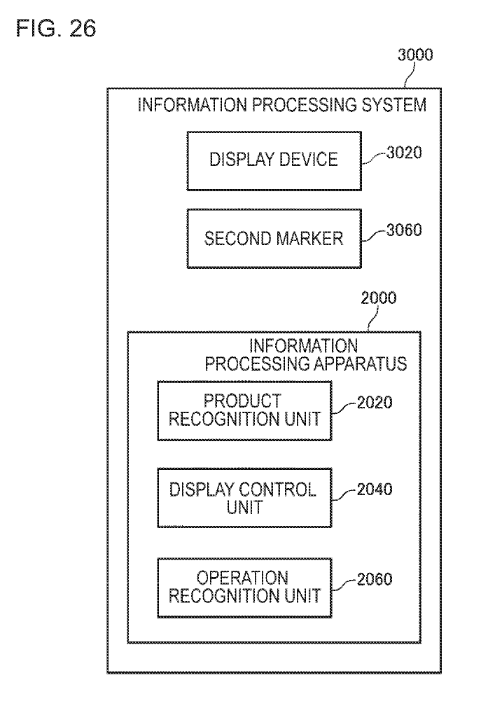

FIG. 26 is a block diagram illustrating an information processing system 3000 according to a third embodiment. The information processing system 3000 of the third embodiment has the same function as those of the information processing systems 3000 of the first and second embodiments, except for the following respects.

The information processing system 3000 of the third embodiment includes a second marker 3060. Similarly to the first marker 3040, the second marker 3060 is a maker that is worn by a user or is a portion of a user's body.

In a case where the second marker 3060 is included in a captured image, the display control unit 2040 of the third embodiment displays the operation screen on the display device 3020.

### <Flow of Processing>

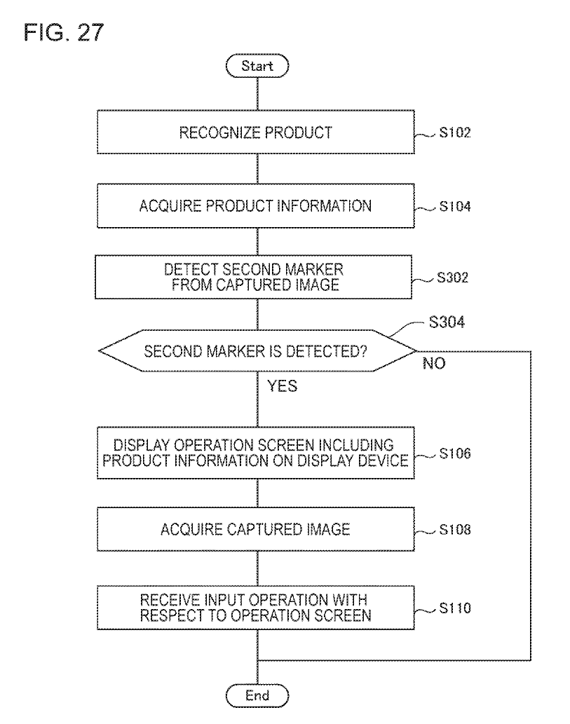

FIG. 27 is a flow chart illustrating a flow of processing executed by the information processing apparatus 2000 of the third embodiment. The flowchart of FIG. 27 is the same as the flow chart of FIG. 4 except for the following things.

The display control unit 2040 detects the second marker 3060 from a captured image (S302). If the second marker 3060 is detected from the captured image (S304: YES), the processing of FIG. 27 proceeds to S108. On the other hand, if the second marker 3060 is not detected from the captured image (S304: NO), the processing of FIG. 27 is terminated.

### <Regarding Second Marker 3060>

Markers that can be used as the second marker 3060 are the same as the markers that can be used as the first marker 3040.

The first marker 3040 and the second marker 3060 may be realized by the same thing. For example, the information processing apparatus 2000 handles the marker image 84 displayed on the device 80 as the first marker 3040 and the second marker 3060. However, the first marker 3040 and the second marker 3060 may be realized by different things.

### <Method of Detecting Second Marker 3060: S302>

A method with which the display control unit 2040 detects the second marker 3060 from a captured image is the same as a method with which the product recognition unit 2020 of the second embodiment detects the first marker 3040 from a captured image. Here, the display control unit 2040 is merely required to recognize that the second marker 3060 be included in the captured image, and is not required to recognize the position of the second marker 3060, except for cases that will be particularly mentioned.

### <Display of Operation Screen: S108>

When the second marker 3060 is detected from the captured image (S304: YES), the display control unit 2040 displays the operation screen on the display control unit 2040 (S108). A method of displaying the operation screen on the display control unit 2040 is as described in the first embodiment.

### <Display of Operation Screen 40 Using Position of Second Marker 3060>

In this embodiment, the display control unit 2040 may determine a display position of the operation screen based on the position of the second marker 3060. In this case, the display control unit 2040 calculates the position of the second marker 3060. Note that, similarly to the method of calculating the position of the first marker 3040, various known techniques of calculating the position of an object detected from an image can be used for a method of calculating the position of the second marker 3060.

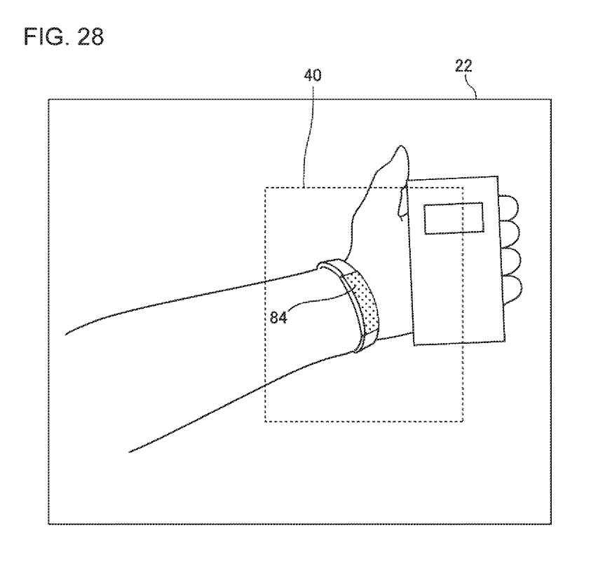

There are various methods of determining a position at which the operation screen is displayed, on the basis of the position of the second marker 3060. For example, the display control unit 2040 sets the center position of the operation screen 40 as the center position of the second marker 3060. FIG. 28 is a first diagram illustrating an operation screen 40 the position of which is determined in accordance with the position of the second marker 3060. In FIG. 28, the center position of the operation screen 40 is the center position of the marker image 84 (second marker 3060). Note that, in FIG. 28, the shape of the operation screen 40 is a rectangular shape in a plane determined by the captured image 22 (for example, the xy plane of FIGS. 16A and 16B). In addition, in FIG. 28, information included in the operation screen 40 is not shown in order to facilitate the viewing of the drawing.

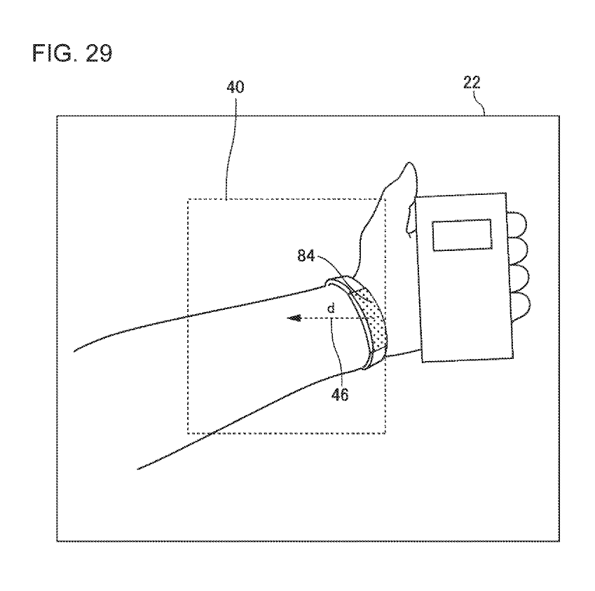

In addition, for example, the display control unit 2040 may set the center position of the operation screen 40 as a position being away from the center position of the second marker 3060 by a predetermined distance in a predetermined direction. FIG. 29 is a second diagram illustrating the operation screen 40 the position of which is determined in accordance with the position of the second marker 3060. In FIG. 29, the center position of the operation screen 40 is a position shifted from the center position of the marker image 84 by a predetermined distance d in a direction, which is determined by an arrow 46. Also in FIG. 29, the shape of the operation screen 40 is a rectangular shape in a plane determined by the captured image 22 (for example, the xy plane of FIGS. 16A and 16B). In addition, also in FIG. 29, information included in the operation screen 40 is not shown.

However, the shape of the operation screen 40 is not limited to a rectangular shape. In addition, the shape of the operation screen 40 may be a rectangular shape in a plane other than the plane determined by the captured image 22. For example, the display control unit 2040 maps the operation screen 40 to a plane in a coordinate system determined by the second marker 3060 (for example, the coordinate system 87 determined by the marker image 84).

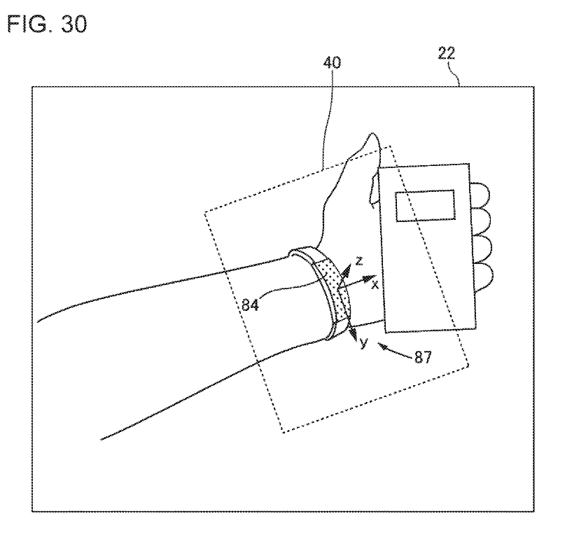

FIG. 30 is a third diagram illustrating the operation screen the position of which is determined in accordance with the position of the second marker 3060. In FIG. 30, the center position of the operation screen 40 is the center position of the marker image 84. In addition, in FIG. 30, the operation screen 40 is mapped to the xy plane of the coordinate system 87 determined by the marker image 84. Note that, also in FIG. 30, information included in the operation screen 40 is not shown.

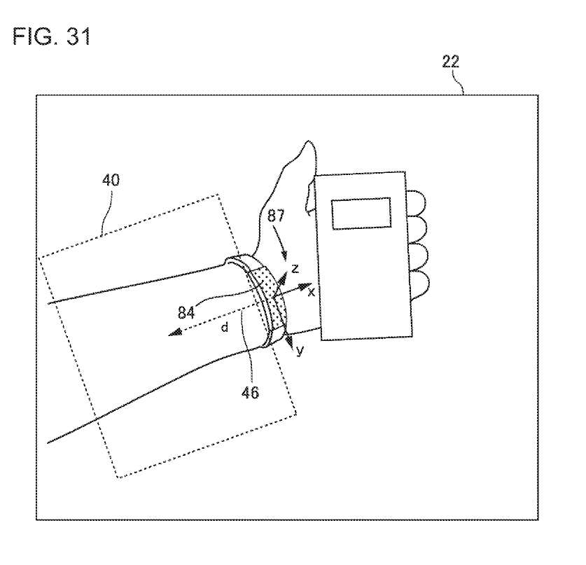

FIG. 31 is a fourth diagram illustrating the operation screen 40 the position of which is determined in accordance with the position of the second marker 3060. In FIG. 31, the center position of the operation screen 40 is a position shifted from the center position of the marker image 84 by a predetermined distance d in a direction, which is determined by an arrow 46. Here, the arrow 46 indicates a direction in the coordinate system 87 determined by the marker image 84. In addition, the operation screen 40 is mapped to the xy plane of the coordinate system 87. Note that, also in FIG. 31, information included in the operation screen 40 is not shown.

Note that, if the information processing apparatus 2000 of the third embodiment has the function of the information processing apparatus 2000 of the second embodiment and the same thing (for example, the marker image 84) is used as the first marker 3040 and the second marker 3060, it is preferable that the direction indicated by the arrow 72 for determining the position of the product recognition region 70 and the direction indicated by the arrow 46 for determining the position of the operation screen 40 are set to different directions. For example, the directions indicated by the arrows 46 of FIGS. 29 and 31 are directions that are directly opposite to the directions indicated by the arrows 72 of FIGS. 18 and 20. In this manner, it is possible to prevent the product recognition region 70 (the location at which the user locates the product 10) and the display position of the operation screen 40 from overlapping each other. In other words, the operation screen 40 does not overlap the product 10, and thus the user can simultaneously view both the product 10 and the operation screen 40.

The position of the operation screen 40 on a captured image is determined on the basis of the position of the second marker 3060 by the above-described various methods. Thus, the display control unit 2040 displays the operation screen 40 on the display device 3020 so that the operation screen 40 is displayed at a position on the display device 3020 corresponding to the determined position on the captured image. As this method, there are a method of displaying the operation screen 40 so as not to be superimposed on the captured image and a method of displaying the operation screen 40 so as to be superimposed on the captured image. Hereinafter, the methods will be described.

<<Method of Displaying Operation Screen 40 without being Superimposed on Captured Image>>

Suppose that the information processing apparatus 2000 is realized using the head mount display 100, and that the display unit 102 of the head mount display 100 is a transparent-type display unit (head mount display 100 is a transparent-type head mount display). In this case, the display device 3020 is realized as the display unit 102 (lens portion) of the transparent-type head mount display 100. In this case, the camera 20 generating a captured image is provided so as to capture the same scene as the scene that the user's eyes capture (camera 20 of FIG. 2, or the like). In a case where the transparent-type head mount display 100 is used, the user can recognize the surrounding scene by viewing real object seen through the display unit 102 (scene on the real world), and the scene is the same scene as the scene included in the captured image. Thus, it is not necessary to display the captured image on the display unit 102.

The display control unit 2040 therefore displays the operation screen 40 on the display device 3020 so as not to be superimposed on the captured image. Specifically, the display control unit 2040 converts the position of the operation screen 40 on the captured image into a position on the display unit 102, and displays the operation screen 40 at the position on the display unit 102 calculated by the conversion.

Correspondence between a coordinate on the captured image and a coordinate on the display unit 102 can be determined on the basis of various parameters relating to the camera 20 (an angle of view, a focal distance, or the like), a positional relationship between the display unit 102 and the camera 20, and the like. The correspondence may be calculated by the display control unit 2040 using the parameters and the like, or may be determined as a setting value in advance.

<<Method of Displaying Operation Screen 40 with being Superimposed on Captured Image>>

When a user cannot directly view the surrounding scene or when a scene seen in a captured image is not the same as the scene that the user's eyes capture (when a direction of the user's eyesight is not captured by the camera 20), the user performs an input operation while viewing the captured image. For example, suppose that the information processing apparatus 2000 is realized using the head mount display 100, and that the display unit 102 of the head mount display 100 is a non-transparent-type display unit (head mount display 100 is a non-transparent-type head mount display). In this case, the user cannot directly view the surrounding scene. Thus, a captured image generated by the camera 20 and including a direction of the user's eyesight is displayed on the display unit 102. The user ascertains the surrounding scene by viewing the captured image. Accordingly, the user performs an input operation while viewing the captured image.

In addition, when the camera 20 is provided in a user's employee ID card or the like, the camera 20 does not necessarily capture a direction of the user's eyesight. In this case, the user performs an input operation while viewing a captured image generated by the camera 20. Note that, in this case, the display device 3020 is realized by, for example, a projector, a stationary display unit (display unit of a PC, or the like), a display unit of a portable terminal, or the like.

As described above, in a case where a user performs an input operation while viewing a captured image, the captured image is displayed on the display device 3020. Thus, the display control unit 2040 displays the operation screen 40 on the display device 3020 by superimposing the operation screen 40 on the captured image displayed on the display device 3020. In this case, the display control unit 2040 superimposes the operation screen 40 on the position of the operation screen 40 on the captured image determined by the above-described various methods (for example, the positions of the operation screens 40 shown in FIGS. 28 to 31 and the like).

<When Second Marker 3060 is not Detected from Captured Image: S304: NO>

In a case where the second marker 3060 is not detected from the captured image (S304: NO), the display control unit 2040 may not display the entire operation screen on the display device 3020, or may display a portion of the operation screen on the display device 3020.

In the latter case, for example, the display control unit 2040 does not display on the display device 3020 an interface portion of the operation image used for an input operation that the user performs (image indicating a keyboard, or the like), but displays on the display device 3020 a portion of the operation image indicating product information. In this manner, a user can view information regarding product even when the second marker 3060 is not included in a captured image.

### <Hardware Configuration>

A hardware configuration of the computer that realizes the information processing apparatus 2000 of the third embodiment is shown by, for example, FIG. 3, similar to the first embodiment. However, program modules realizing the function of the information processing apparatus 2000 of this embodiment are further stored in a storage 1080 of the computer 1000 that realizes the information processing apparatus 2000 of this embodiment.

### Advantageous Effect

According to the information processing apparatus 2000 of this embodiment, when the second marker 3060 is included in a captured image, the operation screen 40 is displayed. Accordingly, similarly to the case of the second embodiment, the user can make the operation screen 40 displayed only when necessary, and thus the user convenience of the information processing system 3000 is improved. In addition, it is possible to prevent computer resources of the information processing apparatus 2000 from being wasted.

Further, when the position of the operation screen 40 is determined in accordance with the position of the second marker 3060, the operation screen 40 can be displayed at a natural and conspicuous position for the user. For example, the marker image 84 displayed on the device 80 is handled as the second marker 3060, and the user wears the device 80 on her or his wrist, thereby allowing the operation screen 40 to be displayed in the vicinity of the user's arm portion. In this manner, the user operability of the information processing apparatus 2000 is improved.

### Fourth Embodiment

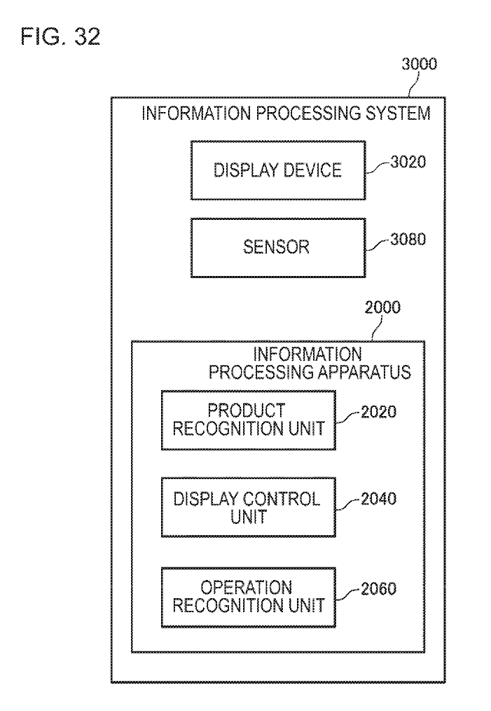

FIG. 32 is a block diagram illustrating an information processing system 3000 according to a fourth embodiment. The information processing system 3000 of the fourth embodiment has the same function as the information processing system 3000 according to any of the first to third embodiment, except for the following things.

The information processing system 3000 of the fourth embodiment includes a sensor 3080. The sensor 3080 is a sensor worn by the user of the information processing system 3000. For example, the sensor 3080 is a vibration sensor.

In this embodiment, in a case where an input operation is recognized on the basis of the position of the operation body, the operation recognition unit 2060 calculates the position of the operation body included in the captured image at a timing determined by a detection result of the sensor 3080, and recognizes the input operation on the basis of the position. In addition, in a case where an input operation is recognized on the basis of the movement of the operation body, the operation recognition unit 2060 calculates the movement of the operation body included in the captured image at time including a timing determined by a detection result of the sensor 3080, and recognizes the input operation on the basis of the calculated movement.

### <Flow of Processing>

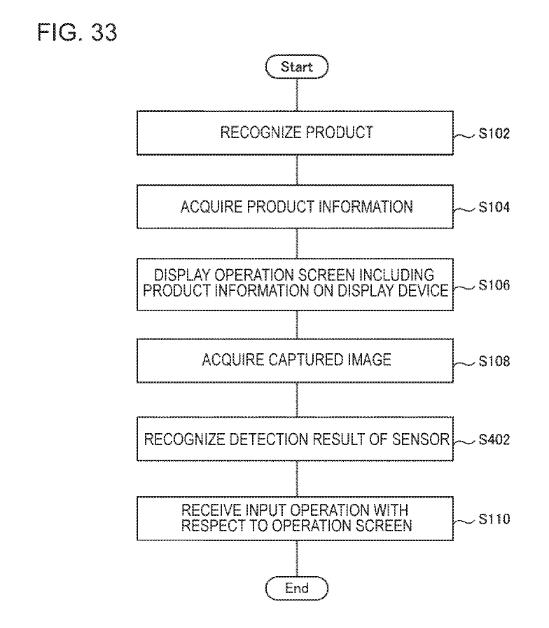

FIG. 33 is a flow chart illustrating a flow of processing executed by the information processing apparatus 2000 according to the fourth embodiment. Processes of S102 to S108 in FIG. 33 are the same as the processes of S102 to S108 in FIG. 5. In S402, the information processing apparatus 2000 recognizes a detection result of the sensor 3080. In addition, in S110, the operation recognition unit 2060 recognizes an input operation on the basis of the position of the operation body included in the captured image at a timing determined by the detection result of the sensor 3080 or the movement of the operation body included in the captured image at time including the above timing.

### <As for Sensor 3080>

The sensor 3080 is any sensor that can be used to recognize a timing of a user's input operation. For example, the sensor 3080 is the above-described vibration sensor. A location where the vibration sensor is provided is arbitrary. For example, the vibration sensor is provided inside the device 80 as described above. In addition, for example, the vibration sensor may be attached to an arm, hand, or the like of the user, or may be provided in the user's clothes (a sleeve of clothes, or the like).

In a case where the sensor 3080 is a vibration sensor, the user applies vibration to the location where the sensor 3080 is worn by the user or in the vicinity of the location at a timing when the user performs an input operation or at a timing close thereto. For example, the user applies vibration to any location of her or his left arm portion using her or his right hand with the user wearing on her or his left wrist the device 80 in which a vibration sensor is built-in. As a result, the vibration is transmitted to the vibration sensor and is detected by the vibration sensor.

In addition, for example, the user applies vibration to other locations using an area of the body to which the sensor 3080 is attached, at a timing when the user performs an input operation or a timing close thereto. For example, the user applies vibration to any location (for example, a desk) using her or his right hand, with the user wearing on her or his right wrist the device 80 in which a vibration sensor is built-in. As a result, the vibration is also transmitted to the vibration sensor, and thus the vibration is detected by the vibration sensor.

Note that, the sensor 3080 is not limited to the vibration sensor. For example, the sensor 3080 may be a pressure sensor or a capacitance sensor. A location where the pressure sensor or the capacitance sensor is provided is arbitrary. For example, the pressure sensor or the capacitance sensor is provided in a touch panel of the device 80. In addition, for example, the pressure sensor or the capacitance sensor may be provided in a sheet which is attached to or wound around an arm, hand, or the like of the user, or the like. In addition, for example, the pressure sensor or the capacitance sensor may be provided in the user's clothes (sleeve of clothes, or the like).

In a case where the sensor 3080 is a capacitance sensor, a user touches a location of her or his body to which the sensor 3080 is attached. Thereby, a change in capacitance is detected by the capacitance sensor. In addition, for example, in a case where the sensor 3080 is a pressure sensor, a user applies pressure to a location of her or his body to which the sensor 3080 is attached. Thereby, the pressure is detected by the pressure sensor.

Note that, an operation for causing detection by the sensor 3080 (operation of applying vibration, or the like) may be performed by the operation body or may be performed using something other than the operation body.

### <Method of Recognizing Detection Result of Sensor 3080: S402>

The information processing apparatus 2000 recognizes the detection result of the sensor 3080 (S402). There are various methods of recognizing the detection result of the sensor 3080 by the information processing apparatus 2000. Hereinafter, the methods will be described.

### <<Use of Wireless Communication>>

For example, the information processing apparatus 2000 performs wireless communication with the device 80 in which the sensor 3080 is built-in to thereby acquire information indicating the detection result of the sensor. The information processing apparatus 2000 recognizes the detection result of the sensor 3080 using the information.

For example, the device 80 transmits a predetermined signal to the information processing apparatus 2000 at a timing when the sensor detects vibration having a predetermined magnitude or greater. In this case, the information processing apparatus 2000 can acquire the detection result of the sensor indicating that “vibration has been detected by the sensor 3080” by receiving the predetermined signal.

In addition, for example, in a case where vibration having a predetermined magnitude or greater is detected by the sensor 3080, the device 80 may transmit information indicating a point in time at which the vibration is detected, to the information processing apparatus 2000.

### <<Detection of Change in Appearance of Device 80>>

The device 80 may change the appearance of the device 80 in accordance with vibration detected by the sensor 3080. In this case, the information processing apparatus 2000 detects a change in the appearance of the device 80 using a captured image generated by the camera 20 to thereby recognize the detection result of the sensor 3080 (the detection of vibration by the sensor 3080).

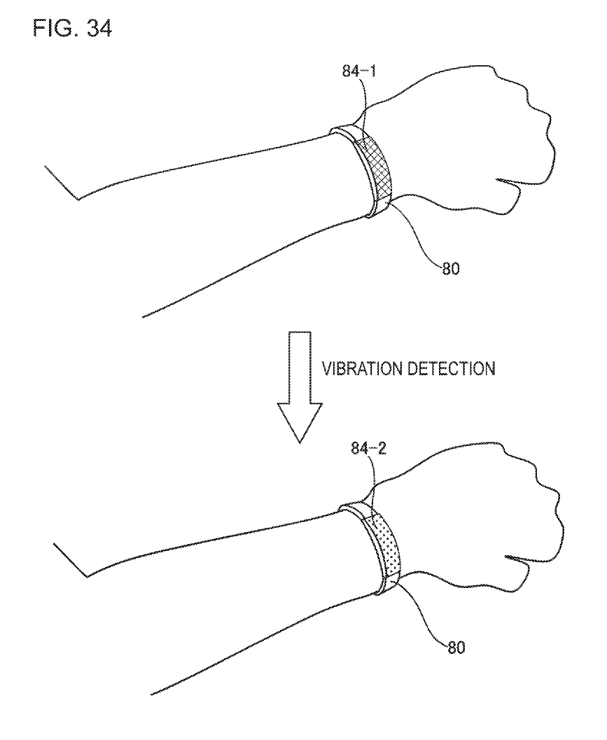

For example, in a case where the device 80 includes a display unit, the device 80 changes the display of the display unit when vibration having a predetermined magnitude or greater is detected by the sensor 3080. More specifically, when vibration having a predetermined magnitude or greater is detected by the sensor 3080, the device 80 changes an image displayed on the display unit of the device 80 or displays a new image on the display unit on which nothing has been displayed. The information processing apparatus 2000 analyzes captured images that are repeatedly generated by the camera 20 to thereby detect the change in the display of the display unit of the device 80. Thereby, the information processing apparatus 2000 recognizes that vibration has been detected by the sensor. FIG. 34 is a diagram illustrating that an image displayed on the display unit of the device 80 is changed when vibration is detected by the sensor 3080.

In addition, for example, in a case where vibration is detected by the sensor 3080, the device 80 may turn on or turn off a backlight of the display unit of the device 80 or a light such as a light emitting diode (LED) light provided on the device 80. The information processing apparatus 2000 analyzes captured images that are repeatedly generated by the camera 20 to thereby detect the turn-on or turn-off of lights thereof. Thereby, the information processing apparatus 2000 recognizes that vibration has been detected by the sensor 3080.

In this manner, when the information processing apparatus 2000 recognizes vibration detected by the sensor 3080 by changing the appearance of the device 80 in accordance with the detection of the vibration, it is not necessary to perform wireless communication between the device 80 and the information processing apparatus 2000. Thus, the device 80 and the information processing apparatus 2000 are not required to have a wireless communication function insofar as there is no other necessity of wireless communication.

A method of recognizing the detection result of a sensor other than a vibration sensor by the information processing apparatus 2000 is similar to the method described above with regard to a vibration sensor. For example, in a case where the sensor is a pressure sensor, when the pressure sensor detects pressure having a predetermined magnitude or greater, the device 80 and the information processing apparatus 2000 perform processes similar to those performed when the vibration sensor detects vibration having a predetermined magnitude or greater. In addition, for example, in a case where the sensor is a capacitance sensor, when the capacitance sensor detects the displacement of capacitance having a predetermined magnitude or greater, the device 80 and the information processing apparatus 2000 perform processes similar to those performed when the vibration sensor detects vibration having a predetermined magnitude or greater.

### <As for Calculation of Position of Operation Body>

The operation recognition unit 2060 detects the operation body at a timing determined by the detection result of the sensor 3080 and calculates the position of the detected operation body. Hereinafter, the term “timing determined by the detection result of the sensor 3080” will be referred to as “detection target timing”.

The detection target timing is a timing when vibration or the like is detected by the sensor 3080 or a timing close thereto. For example, in a case where a predetermined signal is transmitted from the device 80 to the information processing apparatus 2000 when the sensor 3080 detects vibration or the like, the detection target timing is a point in time at which the information processing apparatus 2000 receives the predetermined signal. In addition, for example, in a case where information indicating a point in time at which the sensor 3080 detects vibration or the like is transmitted from the device 80 to the information processing apparatus 2000, the detection target timing is the point in time indicated by the information. In addition, for example, in a case where a predetermined change is made to the appearance of the device 80 when the sensor 3080 detects vibration or the like, the detection target timing is a point in time at which the predetermined change is detected by the information processing apparatus 2000.

In addition, the operation recognition unit 2060 may be configured to handle a point in time preceding or following the above-described various timings (a point in time at which the information processing apparatus 2000 receives a predetermined signal from the device 80, and the like) by a predetermined time, as the detection target timing.

Information indicating which of the above-described points in time is handled as the detection target timing by the operation recognition unit 2060 and information indicating the above-mentioned predetermined time may be set in the operation recognition unit 2060 in advance, or may be stored in a storage device accessible from the operation recognition unit 2060.

The operation recognition unit 2060 detects the operation body from the captured image generated by the camera 20 at the detection target timing, and calculates the position of the operation body. Here, in general, the camera 20 intermittently generates captured images (for example, at a frequency of 30 fps (frames per second)), and thus there may be no captured image generated at the point in time equal to the detection target timing. In this case, for example, the operation recognition unit 2060 uses a captured image generated immediately before and immediately after the detection target timing.

### <Method of Calculating Movement of Operation Body>

The operation recognition unit 2060 detects the operation body during a period determined by the detection target timing and calculates the movement of the operation body. Hereinafter, the term “period determined by the detection target timing” will be referred to as “detection target period”. The operation recognition unit 2060 calculates the movement of the operation body using a captured image generated during the detection target period.

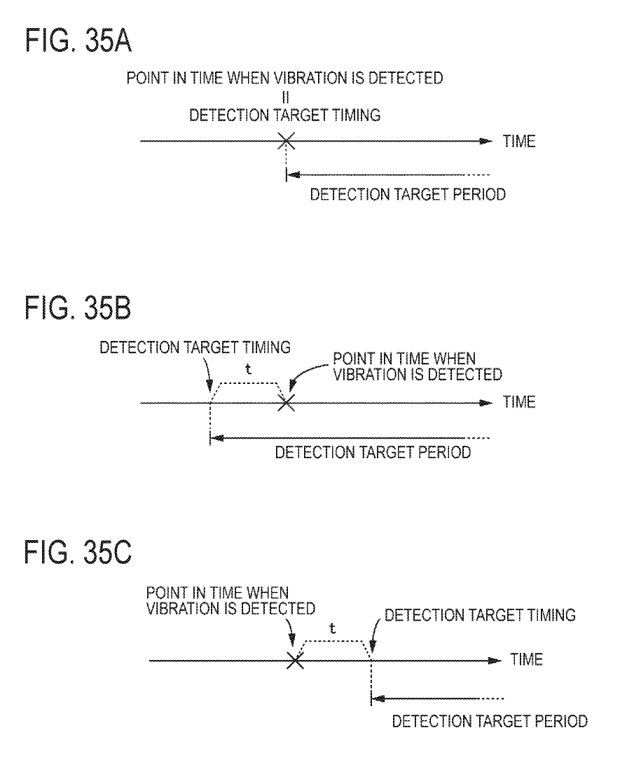

The operation recognition unit 2060 determines points in time at which the detection target period is started and terminated, using a detection target timing. For example, the operation recognition unit 2060 handles the detection target timing as a start point in time of the detection target period. FIGS. 35A to 35C are diagrams illustrating a case where a detection target timing is handled as a start point in time of the detection target period. In the case of FIG. 35A, the operation recognition unit 2060 is configured to handle the point in time at which the sensor 3080 detects vibration as the detection target timing. In the case of FIG. 35B, the operation recognition unit 2060 is configured to handle a point in time preceding the point in time at which the sensor 3080 detects vibration by a predetermined time, as the detection target timing. In the case of FIG. 35C, the operation recognition unit 2060 is configured to handle a point in time following the point in time at which the sensor 3080 detects vibration by the predetermined time, as the detection target timing.

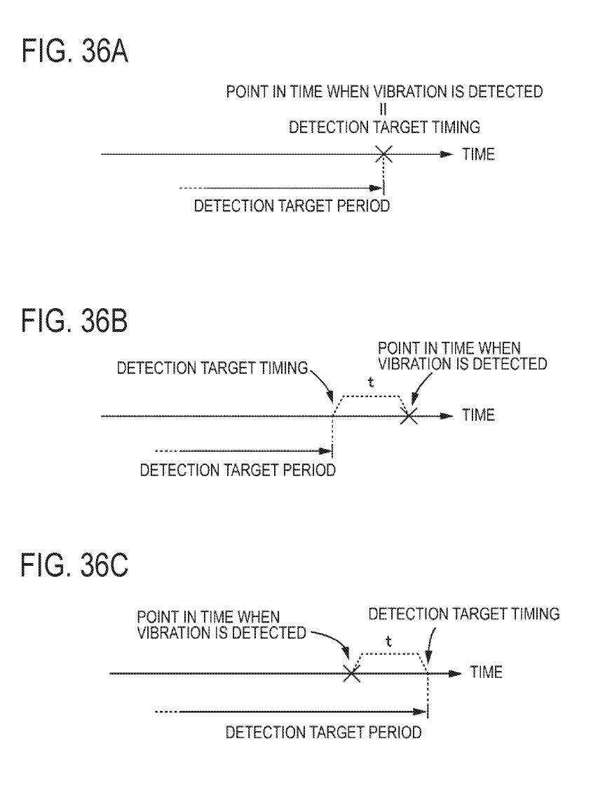

In addition, for example, the operation recognition unit 2060 handles the detection target timing as an end point in time of the detection target period. FIGS. 36A to 36C are diagrams illustrating a case where a detection target timing is handled as an end point in time of the detection target period. In the case of FIG. 36A, the operation recognition unit 2060 is configured to handle a point in time at which the sensor 3080 detects vibration as the detection target timing. In the case of FIG. 36B, the operation recognition unit 2060 is configured to handle a point in time preceding the point in time at which the sensor 3080 detects vibration by a predetermined time, as the detection target timing. In the case of FIG. 36C, the operation recognition unit 2060 is configured to handle a point in time following the point in time at which the sensor 3080 detects vibration by the predetermined time, as the detection target timing.

The operation recognition unit 2060 determines the detection target period using one or two detection target timings. In a case where the detection target period is determined using one detection timing, the operation recognition unit 2060 determines both of the start point in time and the end point in time of the detection target period. For example, the operation recognition unit 2060 determines the start point in time of the detection target period with one of the methods of FIGS. 35A to 35C, and determines the end point in time of the detection target period as the point in time following the start point in time by predetermined time. In addition, for example, the operation recognition unit 2060 determines the end point in time of the detection target period with one of the methods of FIGS. 36A to 36C, and determines the start point in time of the detection target period as a point in time preceding the end point in time by a predetermined time.

In a case where the detection target period is determined using two detection target timings, the operation recognition unit 2060 determines the start point in time of the detection target period using the earlier detection target timing with one of the methods of FIGS. 35A to 35C, and determines the end point in time of the detection target period using the later detection target timing with one of the methods of FIGS. 36A to 36C.

Note that, in a case where the start point in time of the detection target period is determined as a point in time preceding the timing at which the sensor 3080 detects vibration (FIG. 35A or 35B) or in a case where the end point in time of the detection target period is determined as depicted in FIG. 36 using one detection target timing, the camera 20 needs to generate a captured image before the sensor 3080 detects vibration. In this case, the camera 20 starts capturing before the sensor 3080 detects vibration. For example, the camera 20 continuously performs capturing from when a user starts using the information processing apparatus 2000 to when the user terminates the use of the information processing apparatus 2000. In addition, the captured image generated by the camera 20 is continuously stored in a storage device or the like for a predetermined period.

On the other hand, in a case where the start point in time of the detection target period is determined as a point in time following the timing at which the sensor 3080 detects vibration (FIG. 35C), the camera 20 may start capturing after the sensor 3080 detects vibration. In this case, for example, the camera 20 receives a signal indicating that vibration is detected by the sensor 3080, from the device 80 or the information processing apparatus 2000, and starts capturing when the signal is received.

However, in a case where product 10 is recognized using a captured image, the camera 20 starts capturing at a timing which is necessary for the recognition of the product 10. For example, in this case, the camera 20 generates a captured image at all times between the start-up and stop of the information processing apparatus 2000.

Note that, information indicating each of the above-described predetermined times may be set in the operation recognition unit 2060 in advance, or may be stored in a storage device accessible from the operation recognition unit 2060. In addition, a predetermined time used to determine the start point in time of the detection target period and a predetermined time used to determine the end point in time of the detection target period may be the same as or different from each other.

### <Example of Hardware Configuration>

A hardware configuration of the computer that realizes the information processing apparatus 2000 of the fourth embodiment is shown by, for example, FIG. 3, similar to the first embodiment. However, program modules realizing the function of the information processing apparatus 2000 of this embodiment are further stored in a storage 1080 of the computer 1000 that realizes the information processing apparatus 2000 of this embodiment.

### <Advantageous Effects>

When a user's input operation is subjected to be recognized using only the position or movement of the operation body included in the captured image, there is the possibility that an input operation is erroneously recognized in spite of the input operation not being performed by the user, or that an input operation is not recognized in spite of an input operation being performed by the user.

According to the information processing system 3000 of this embodiment, an input operation is recognized by analyzing the position of the operation body at a timing based on the detection result of the sensor 3080 worn by a user or the movement of the operation body during a period determined by a timing determined by the detection result of the sensor 3080. Thus, when the user performs an input operation so that the sensor 3080 performs the detection during the input operation, it is highly probable that the position or movement of the operation body based on the timing indicates the user's input operation. The input operation intentionally performed by the user is therefore correctly recognized, and it is possible to prevent the input operation from being erroneously recognized in spite the input operation not being performed by the user or to prevent the input operation from not being recognized in spite of the input operation being performed by the user.

### Examples of Information Processing System 3000

Hereinafter, a more specific method of using an information processing system 3000 will be described. Examples to be described later are merely examples of a method of using the information processing system 3000, and the method of using the information processing system 3000 is not limited to methods described in the examples to be described later.

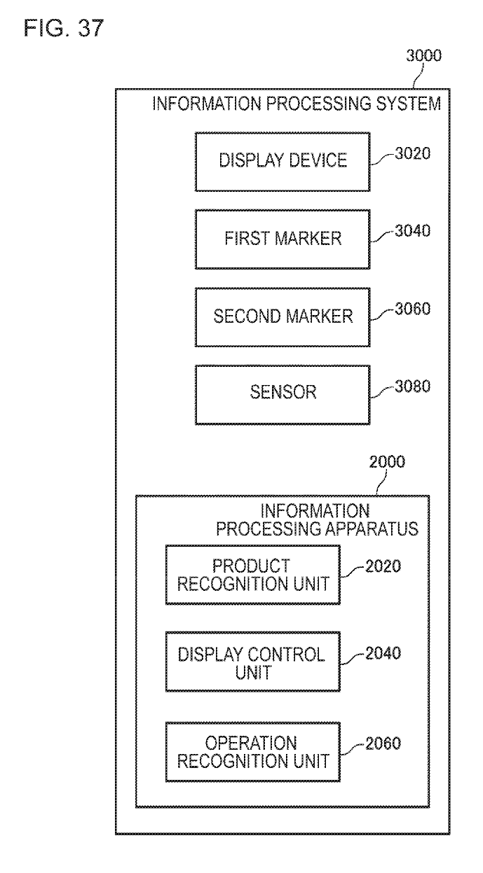

FIG. 37 is a block diagram illustrating a configuration of an information processing system. 3000 that is common to the examples. The information processing system 3000 includes the information processing apparatus 2000, the display device 3020, the first marker 3040, the second marker 3060, and the sensor 3080.

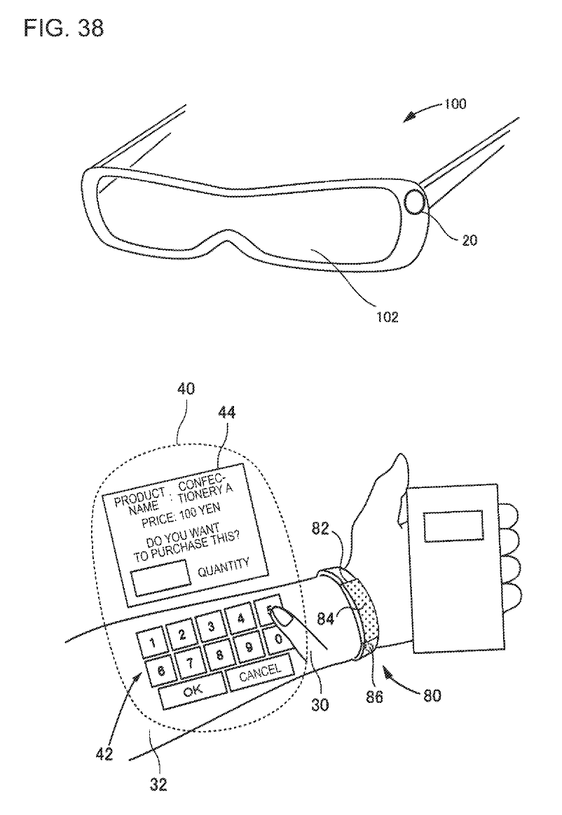

FIG. 38 is a diagram illustrating a usage environment of the information processing system 3000 that is common to the examples. In the examples, the information processing apparatus 2000 is mounted inside the head mount display 100. The head mount display 100 includes a display unit 102 for realizing the display device 3020. In addition, the camera 20 is provided in the head mount display 100.

A user wears the device 80 on her or his wrist. The marker image 84 is displayed on the touch panel 82 of the device 80. The marker image 84 is handled as both the first marker 3040 and the second marker 3060 by the information processing apparatus 2000. In other words, a product recognition unit 2020 recognizes product 10 included in the product recognition region 70 that is determined by the marker image 84. In addition, the display control unit 2040 displays the operation screen 40 on the display device 3020 in a case where the marker image 84 is included.

The display control unit 2040 determines a display position of the operation screen 40 on the basis of the position of the marker image 84. Here, the operation screen 40 includes either one or both of an input area 42 and an information area 44. The input area 42 is a region including an input interface such as a keyboard or a button, and the information area 44 is a region that does not include an input interface.

Display positions of the input area 42 and the information area 44 are determined on the basis of the position of the marker image 84. Specifically, the display position of the input area 42 is determined as a position superimposed on a user's arm portion. On the other hand, the information area 44 is displayed so that the display position of the information area 44 is located above the user's arm portion.

In the examples, the operation body is a finger 30 of the user. In addition, the device 80 includes a vibration sensor 86 for realizing the sensor 3080. The operation recognition unit 2060 recognizes an input operation on the basis of the position of the finger 30 at the detection target timing determined on the basis of a detection result of the vibration sensor 86 or the movement of the finger 30 within the detection target period.

For example, the user taps on each key included in the input area 42 indicating a keyboard using the finger 30. When the vibration sensor 86 detects vibration occurred by the tapping, the device 80 gives a notice to the operation recognition unit 2060. The operation recognition unit 2060 receives the notice, determines the position of the finger 30 at a timing when the vibration is detected, and recognizes an input operation of inputting a key corresponding to the position. In addition, the user taps on an arm 32 using the finger 30 and then moves the finger 30, and taps on the arm 32 again using the finger 30 at a timing when terminating the operation. In this manner, the operation recognition unit 2060 recognizes the movement of the finger 30. For example, the user performs a handwriting input or the like through the movement of the finger 30.

### First Example

The first example is an example in which the head mount display 100 is used by a customer who visits a store. In this store, the device 80 and the head mount display 100 are lent to each customer who visits the store. An individual ID is allocated to each head mount display 100. The customer wears the device 80 and the head mount display 100, and looks around to browse products 10 in the store.

In this store, the customer does not need to put a product that the customer desires to purchase in a basket and to carry the product. Instead, the customer performs a purchase procedure of a product 10 using the head mount display 100. For this reason, a sample of the product 10 is displayed in the store.

First, the customer walks through the store and finds out a product 10 that the customer desires to purchase. When the customer finds out a product 10 attracting the customer, the customer makes the head mount display 100 recognize the product 10. Specifically, the customer holds the product 10 in her or his hand on which the device 80 is worn, and views the product 10. Then, the product recognition unit 2020 recognizes the product 10. In addition, the display control unit 2040 displays the operation screen 40 including the product information regarding the product 10 on the display unit 102.

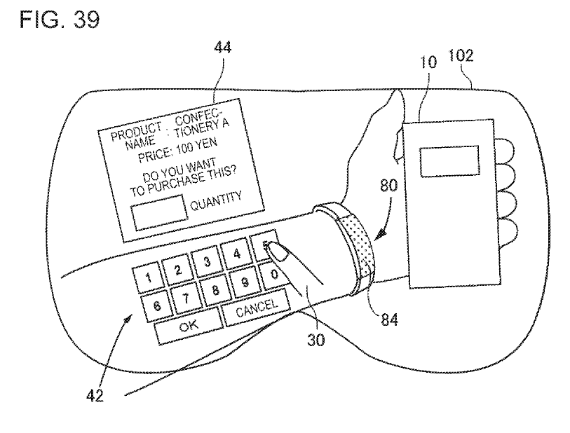

FIG. 39 is a diagram illustrating the operation screen 40 displayed on the display unit 102 in the first example. The display unit 102 displays the information area 44 including the explanation of the product 10 and the input area 42 for inputting the number of the products 10 to be purchased. The input area 42 includes numeric keys for inputting the number of the products, an OK key for determining purchase, and a cancel key for cancelling purchase.

The user views the information area 44 and confirms the information regarding the product 10 (the product name and the price in FIG. 39). If the product 10 is desired to be purchased, the user inputs the number of the products desired to be purchased using the numeric keys, and then taps on the OK key. On the other hand, if the user does not purchase the product 10, the user taps on the cancel key.

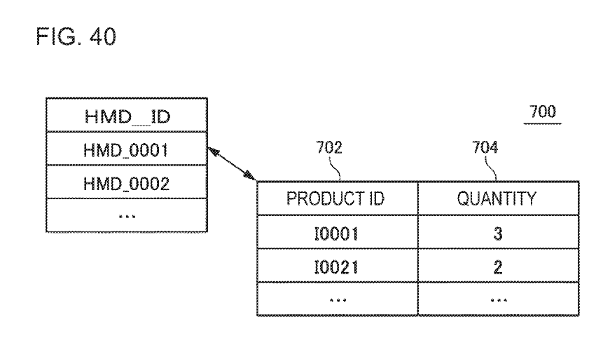

When the user taps on the OK key, the product 10 is added to order information associated with the ID of the head mount display 100. FIG. 40 is a diagram illustrating the order information in a table format. The table shown in FIG. 40 is referred to as an order information table 700. The order information table 700 is associated with the ID of the head mount display 100 (HMD_ID). The order information table 700 includes a product ID 702 and a quantity 704. The product ID 702 indicates the ID of product 10. The quantity 704 indicates the number of products 10 to be purchased. When the OK key is tapped through the operation described in FIG. 39, a new row is added to the order information table 700.

When the operation described in FIG. 39, which is performed on each product 10 desired to be purchased, is terminated, the user goes to a cashier to check out. The user returns the device 80 and the head mount display 100 to a salesclerk at the cashier. The salesclerk having received the head mount display 100 reads out the ID of the head mount display 100 by a computer provided at the cashier. The computer acquires the order information table 700 associated with the ID of the head mount display 100 to calculate a payment, and displays the payment on a display unit that can be viewed by the customer. The user pays the payment and then receives the products from the salesclerk.

Note that, the payment may be performed without using cash. For example, the user may input information regarding a credit card using the head mount display 100 to thereby perform the payment using the credit card.

It is preferable that the head mount display 100 has a function of handling multiple languages. In a case where the head mount display 100 has a function of handling multiple languages, for example, the user tells a salesclerk the language that the user desires to use when borrowing the head mount display 100. Here, suppose that it is English that the user desires to use. In this case, the salesclerk changes the language setting of the head mount display 100 to English, and then lends the head mount display 100 to the user. In this manner, information displayed in the information area 44 and the language of the input keys displayed in the input area 42 are displayed with English.

In this manner, the head mount display 100 has a function of handling multiple languages, and thus people of various countries easily use the head mount display 100 and also easily use stores introducing the head mount display 100. Note that, the language setting of the head mount display 100 may be changed by a user.

### Second Example

A second example is an example in which the head mount display 100 is used in a concierge service through the Internet. The term “concierge service” as used herein refers to a service in which a request from a customer relating to a product 10 is received and the product 10 matched to the request is provided to the customer.

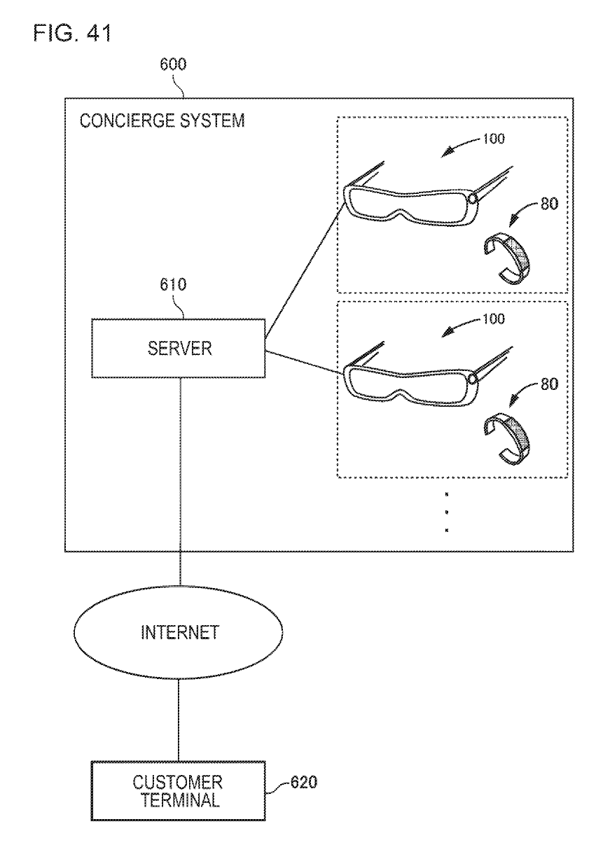

FIG. 41 is a diagram illustrating a configuration of a concierge system 600 that provides the concierge service of the second example. The concierge system 600 includes a server 610, the device 80, and the head mount display 100. Note that, in the concierge system 600, each concierge staff wears a set of the device 80 and the head mount display 100.

The customer terminal 620 is any of various terminals that is used by a customer (for example, a PC). The customer terminal 620 is connected to the server 610 through the Internet. When the server 610 receives a request for providing service from the customer terminal 620, the server allocates the request to any one of the head mount displays 100. The concierge staff wearing the head mount display 100 to which the request has allocated provides service to the user of the customer terminal 620 (customer). Here, the head mount display 100 is connected to the server 610 through a local area network (LAN).

The concierge staff receives the request relating to the product 10 from the customer. For example, the customer conveys the request by sound through a microphone connected to the customer terminal 620. The customer's sound is transmitted to the server 610 through the customer terminal 620. Note that, various known techniques can be used for a method in which a service provider listens to the customer's sound transmitted to a server through the Internet.

The concierge staff finds out a product 10 matched to the customer's request, and views the product 10 through the head mount display 100. In this manner, the operation screen 40 including the product information regarding the product 10 is displayed on the display unit 102. In a case where the customer likes the product 10, the concierge staff asks the customer the number of the products that the customer desires to purchase, and performs an input operation of inputting the number of the products to the operation screen 40. Here, the information displayed on the display unit 102 of the head mount display 100 worn by the concierge staff is similar to, for example, the input area 42 and the information area 44 that are shown in FIG. 39.

The customer may receive the information regarding the product 10 by sound from the concierge staff, or may view the information regarding the product 10 using a display unit of the customer terminal 620. In the latter case, for example, the server 610 provides the customer terminal 620 with information that is the same as or similar to the information viewed by the concierge staff. In this manner, the display unit of the customer terminal 620 displays the information that is the same as or similar to the information viewed by the concierge staff, and the customer can view the information.

For example, the server 610 transmits a video generated by the camera 20 mounted on the head mount display 100 to the customer terminal 620. In addition, for example, the server 610 transmits a video displayed on the display unit 102 (a video that is generated by the camera 20, and on which the operation screen 40 is superimposed) to the customer terminal 620. In addition, for example, the server 610 may transmit only the operation screen 40 to the customer terminal 620 without transmitting the video generated by the camera 20 to the customer terminal 620.

Note that, the operation screen 40 transmitted to the customer terminal 620 may be different from the operation screen 40 viewed by the concierge staff. For example, in the case of this example, the customer does not perform an input operation using the head mount display 100, and thus does not need to view the input area 42. Thus, in the head mount display 100, both of the input area 42 and the information area 44 are included in the operation screen 40 displayed on the display unit 102, whereas only the information area 44 is included in the operation screen 40 transmitted to the customer terminal 620 through the server 610.

In addition, the product information viewed by the concierge staff and the product information transmitted to the customer terminal 620 may be different from each other. For example, the head mount display 100 integrates various pieces of management information necessary for the management of products into the product information viewed by the concierge staff, while not integrating such management information into the product information transmitted to the customer terminal 620.

In this manner, in a case where the operation screen 40 displayed on the display unit 102 and the operation screen 40 transmitted to the customer terminal 620 are configured to be different from each other, both a template for the display unit 102 and a template for the customer terminal 620 are provided as the template 200 of the above-mentioned operation screen 40.

### Third Example

A third example is an example in which the head mount display 100 is used in an operation of replenishing a vending machine with products. A worker who performs the operation of replenishing the vending machine with products views various pieces of information regarding products 10 with which replenishment is performed or inputs information regarding the products 10 by using the head mount display 100.

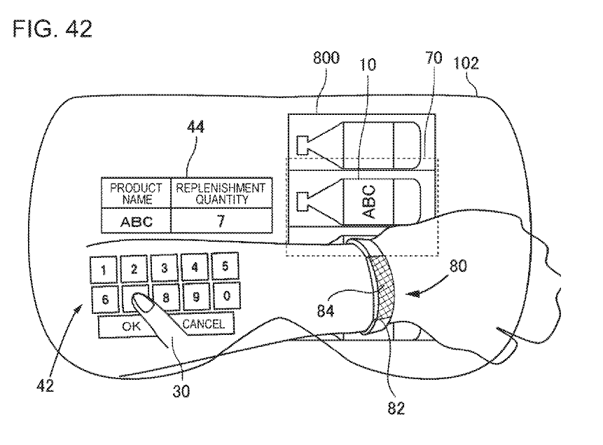

For example, the worker performs an input operation of recording the number of the products 10 with which replenishment is performed, using the head mount display 100. FIG. 42 is a diagram illustrating that the head mount display 100 is used in the third example. A product storage space 800 is a storage space that is installed in the vending machine and in which products are stored. Note that, FIG. 42 shows only a portion of the product storage space 800, in order to facilitate the viewing of the drawing.

First, the worker performs replenishment with a product 10 and then views the product 10 viewed from the product storage space 800, through the head mount display 100, thereby making the head mount display 100 recognize the product 10.

Here, in this example, the device 80 is mounted so that the touch panel 82 is viewed on the back side of a hand. In addition, the product recognition region 70 is a rectangle contacting with an upper end of the marker image 84. Thus, the worker holds the marker image 84 up in the vicinity of the product 10 viewed from the product storage space 800, so that the product 10 is included in the product recognition region 70.

When the product 10 is recognized by the head mount display 100, the operation screen 40 (the input area 42 and the information area 44) is displayed on the display unit 102. The worker performs an input operation of inputting the number of the products with which replenishment is performed, using numeric keys included in the operation screen 40.

Note that, the operation screen 40 may include a note section in which the worker can freely write information. For example, the worker inputs information regarding whether to increase or decrease the number of the products 10 to be brought at the time of the next replenishment, with respect to each product 10.

In this example, the head mount display 100 may have a function of specifying a vending machine that is a target for an operation and acquiring a list of pieces of the products 10 to be put into the specified vending machine. For example, the specification of the vending machine is realized by reading out an ID attached to the vending machine.

For example, suppose that a QR Code™ obtained by encoding the ID of the vending machine is attached to the vending machine. In this case, the worker views the QR Code™ through the head mount display 100. As a result, the camera 20 generates the captured image in which the QR Code™ is included. The head mount display 100 analyzes the captured image to thereby recognize the ID of the vending machine.

The head mount display 100 searches for a database in which the ID of the vending machine and a list of the products 10 to be put into the vending machine specified by the ID are associated with each other, to thereby acquire the list of the products 10. In this case, the head mount display 100 is communicably connected to the database. However, the list of the products 10 to be put into the vending machine may be stored in advance in a storage device provided inside the head mount display 100.

Note that, the vending machine that is a target for an operation may be manually specified. In this case, the worker performs on the head mount display 100 an input operation of selecting a vending machine that is a target for an operation. For example, the head mount display 100 displays a list of vending machines each of which could be a target for an operation on the display unit 102. The worker selects from the list a vending machine that is a target for an operation to be performed from now.

The head mount display 100 may have a function of communicating with the vending machine. In this case, for example, the vending machine transmits information indicating the number of products 10 with which replenishment is performed and the like to the head mount display 100. The head mount display 100 displays the information on the display unit 102. The worker can ascertain the number of the products 10 with which replenishment is to be performed, by viewing the information.

In addition, the vending machine may have a function of counting the number of the product 10 with which replenishment has been performed and notifying the head mount display 100 of the number of the products 10 with which replenishment has been performed. In this case, the number of the products 10 with which replenishment has been performed may be automatically recorded by the head mount display 100. Thus, the worker does not need to perform an input operation of inputting the number of the products 10 with which replenishment has been performed.

### Fourth Example

A fourth example is an example in which, in a supermarket providing an Internet shopping service, the head mount display 100 is used for an operation of collecting products ordered in Internet shopping from product shelves of a store. When a customer orders products in Internet shopping, a list of the ordered products is transmitted to a server of the store. A salesclerk of the store walks around the store and collects the products on the list from the product shelves. At this time, the salesclerk performs a collection operation with wearing the head mount display 100.

A store server acquires the list of the ordered product and a map of the store. Further, the store server searches for a product database and determines the position of each of the ordered products that are on the list in the store. The position of each product is recorded in the product database in advance. In addition, the store server generates a map on which a mark indicating the position of each product is superimposed.

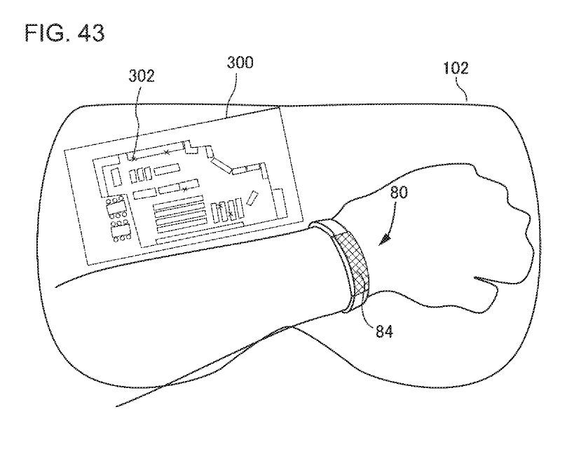

The head mount display 100 acquires the map from the store server and displays the acquired map on the display unit 102. FIG. 43 is a diagram illustrating the map of the store displayed on the display unit 102. In FIG. 43, a map 300 is displayed on the display unit 102. A product position 302 indicating the position of each product on the above-mentioned list (position of each product to be collected by the salesclerk) is superimposed on the map 300. The salesclerk can collect products while viewing the map 300 to thereby easily collect target products.

The salesclerk views the map displayed on the display unit 102 and goes to a product shelf on which the product to be collected is displayed. In addition, when the salesclerk finds out the product to be collected, the salesclerk views the product through the head mount display 100. The head mount display 100 displays the operation screen 40 including the product information regarding the product on the display unit 102.

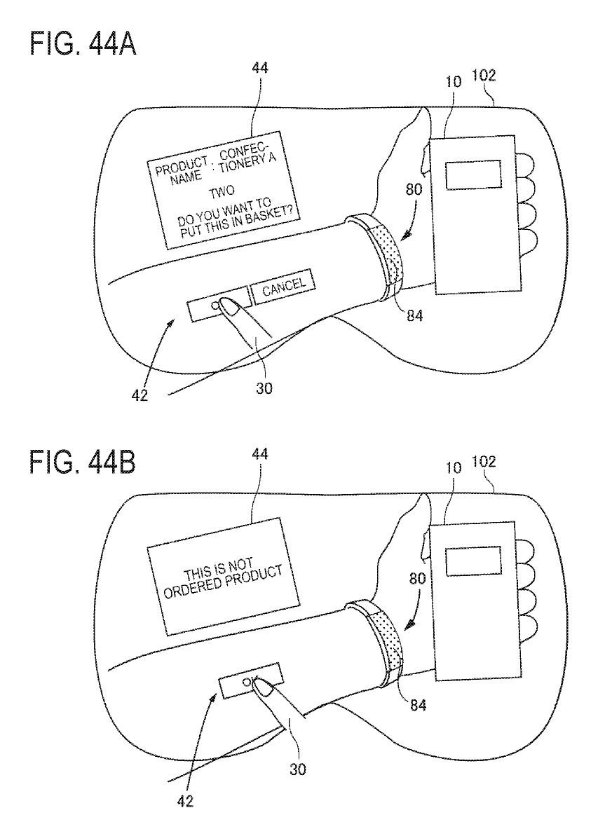

FIGS. 44A and 44B are diagrams illustrating the operation screen 40 displayed on the display unit 102 in the fourth example. FIG. 44A shows a case where the product 10 to be collected is held in a salesclerk's hand. The number of the products 10 to be collected is displayed on the operation screen 40. The salesclerk puts the displayed number of the products into a basket, and then taps on the OK button. On the other hand, in a case where the salesclerk postpones the collection of the product 10, the salesclerk taps on a cancel button.

On the other hand, FIG. 44B shows a case where the product 10 held in the salesclerk's hand is not a product to be collected. The operation screen 40 shows a message for notifying that the product in the salesclerk's hand is not a product to be collected (not an ordered product). The user having confirmed the message taps on the OK button.

Note that in a case of a salesclerk who is unfamiliar with the store, such as a new salesclerk, the salesclerk may not find out a target product even if the salesclerk views the map 300 displayed on the display unit 102. In this case, the head mount display 100 may provide means for getting in touch with a person in charge of each section.

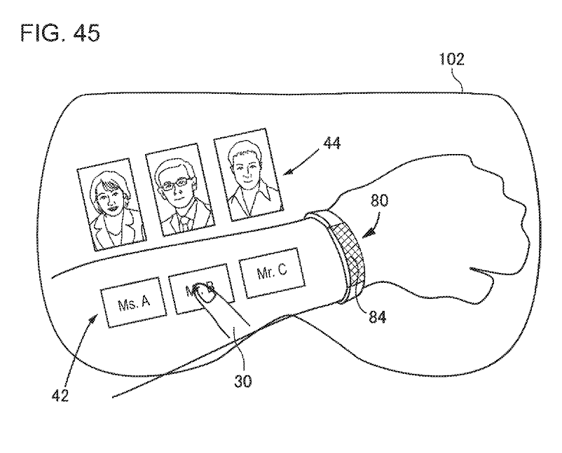

FIG. 45 is a diagram illustrating the display unit 102 that displays the operation screen 40 for getting in touch with a person in charge of a section. The information area 44 includes photographs of people in charge of respective sections. The input area 42 includes buttons indicating names of the people in charge of the respective sections. The salesclerk taps on the button indicating the name of the person in charge of the section that the salesclerk desires to get in touch with. Thereby, for example, voice call is established between the salesclerk and the person in charge of the section. In this case, the head mount display 100 provides a function of performing voice call.

### Fifth Example

A fifth example shows a case where the head mount display 100 is used for the management of products in a store. The head mount display 100 is worn by a salesclerk. For example, the salesclerk wearing the head mount display 100 performs an operation of ordering the product 10 using the head mount display 100.

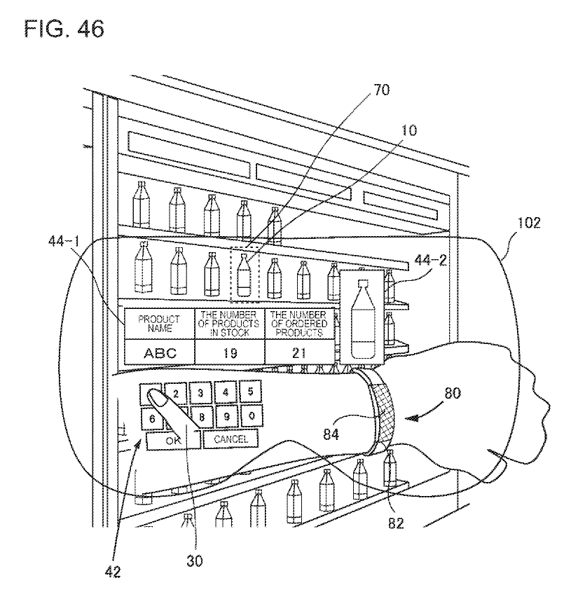

FIG. 46 is a diagram illustrating information displayed on a display unit 102 in the fifth example. The display unit 102 displays the information area 44 including information regarding the product 10 included in the product recognition region 70, and displays the input area 42 for performing an input operation. Here, the information area 44 includes an information area 44-1 and an information area 44-2. The information area 44-1 includes a table showing a product name of the recognized product 10, the number of the products in stock, and the number of the products to be ordered. The information area 44-2 includes a large image of the recognized product 10. Here, the image of the product 10 included in the information area 44-2 may be the image obtained by enlarging the image of the product 10 extracted from the captured image, or may be the image of the product 10 registered in a product database (for example, the product information table 500).

The salesclerk views the number of the products 10 in stock shown in the information area 44 and determines the number of the product 10 to be ordered. In addition, the salesclerk inputs the number of the products to be ordered using numeric keys in the input area 42. In FIG. 46, “21” is input as the number of the products to be ordered. The salesclerk taps on the OK key after finishing the input of the number of the products to be ordered. In this manner, the ordering of the product 10 is performed.

As described above, the embodiments of the invention have been described with reference to the accompanying drawings, but are illustrative of the invention. A combination of the above-described embodiments or various configurations other than the above-described configurations can also be adopted.

For example, even though the information processing apparatus 2000 is configured to handle products in the above exemplary embodiments, the information processing apparatus 2000 may be configured to handle arbitrary objects that can be captured by a camera. The objects may be, for example, facilities, houses, people, or animals. The information processing apparatus 2000 recognizes an object in the captured image in the similar manner that the product recognition unit recognizes a product in the captured image. In addition, the information processing apparatus 2000 acquires information regarding the recognized object and controls the display device 3020 to display the operation screen 40 including the acquired information, in the similar manner that the display control unit 2040 acquires product information regarding the recognized object and controls the display device 3020 to display the operation screen 40 including the acquired product information.

Hereinafter, an example of a reference configuration will be appended.

(Appendix 1) An information processing apparatus to be coupled with a display device, the apparatus comprising a hardware processor configured to:

extract a partial region of a captured image as an object recognition region;

recognize an object in the object recognition region;

acquire object information regarding the recognized object;

control the display device to display an operation screen and the acquired object information;

recognize an operation body in the captured image; and

recognize an input operation with respect to the operation screen on the basis of at least one of a position and a movement of the operation body.

(Appendix 2) The information processing apparatus of Appendix 1,

wherein the hardware processor further configured to recognize the object by at least one of:

extracting an image of the object from the captured image; or

reading an identifier of the object from a symbol that is attached to the object.

(Appendix 3) The information processing apparatus of Appendix 1, wherein the object recognition region is determined based on a position of a marker in the captured image.
(Appendix 4) The information processing apparatus of Appendix 1, wherein the object recognition region is predetermined.
(Appendix 5) The information processing apparatus of Appendix 1,

wherein the hardware processor is further configured to control the display device to display the operation screen when the marker is included in the captured image, and

wherein the hardware processor is further configured not to control the display device to display the operation screen when the marker is not included in the captured image.

(Appendix 6) The information processing apparatus of Appendix 5,

wherein the hardware processor is further configured to control the display to display the operation screen at a position determined on the basis of a position of the marker that is included in the captured image.

(Appendix 7) The information processing apparatus of Appendix 3,

wherein the marker is an image that is displayed on a display unit of a device worn by the user.

(Appendix 8) The information processing apparatus of Appendix 1,

wherein the hardware processor is further configured to transmit the operation screen or the captured image on which the operation screen is superimposed through a communication line.

(Appendix 9) The information processing apparatus of Appendix 1 to be further coupled with a sensor that is worn by a user of the apparatus,

wherein the hardware processor is further configured to:

detect a position of the operation body in the captured image at a timing determined by a detection result of the sensor or detect a movement of the operation body in the captured image at a period including the timing; and

recognize an input operation on the basis of the detected position or movement.

(Appendix 10) An information processing system comprising:

an information processing apparatus; and

a display device to be coupled with the information apparatus;

wherein the apparatus comprising a hardware processor configured to:

extract a partial region of a captured image as an object recognition region;

recognize an object in the object recognition region;

acquire object information regarding the recognized object;

control the display device to display an operation screen and the acquired object information;

recognize an operation body in the captured image; and

recognize an input operation with respect to the operation screen on the basis of at least one of a position and a movement of the operation body.

(Appendix 11) The information processing system of Appendix 10,

wherein the hardware processor further configured to recognize the object by at least one of:

extracting an image of the object from the captured image; or

reading an identifier of the object from a symbol that is attached to the object.

(Appendix 12) The information processing apparatus of Appendix 10, wherein the object recognition region is determined based on a position of a marker in the captured image.
(Appendix 13) The information processing system of Appendix 10, wherein the object recognition region is predetermined.
(Appendix 14) The information processing system of Appendix 10,

wherein the hardware processor is further configured to control the display device to display the operation screen when the marker is included in the captured image, and

wherein the hardware processor is further configured not to control the display device to display the operation screen when the marker is not included in the captured image.

(Appendix 15) The information processing system of Appendix 14,

wherein the hardware processor is further configured to control the display to display the operation screen at a position determined on the basis of a position of the marker that is included in the captured image.

(Appendix 16) The information processing system of Appendix 12,

wherein the marker is an image that is displayed on a display unit of a device worn by the user.

(Appendix 17) The information processing system of Appendix 10,

wherein the hardware processor is further configured to transmit the operation screen or the captured image on which the operation screen is superimposed through a communication line.

(Appendix 18) The information processing system of Appendix 10 further comprising a sensor to be coupled with the information processing apparatus, the sensor being worn by a user of the apparatus,

wherein the hardware processor is further configured to:

detect a position of the operation body in the captured image at a timing determined by a detection result of the sensor or detect a movement of the operation body in the captured image at a period including the timing; and

recognize an input operation on the basis of the detected position or movement.

(Appendix 19) A control method to be executed by a computer to be coupled with a display device, the method comprising:

extracting a partial region of a captured image as an object recognition region;

recognizing an object in the object recognition region;

acquiring object information regarding the recognized object;

controlling the display device to display an operation screen and the acquired object information;

recognizing an operation body in the captured image; and

recognizing an input operation with respect to the operation screen on the basis of at least one of a position and a movement of the operation body.

(Appendix 20) The control method of Appendix 19,

wherein the object is recognized by performing at least one of:

extracting an image of the object from the captured image; or

reading an identifier of the object from a symbol that is attached to the object.

(Appendix 21) The control method of Appendix 19, wherein the object recognition region is determined based on a position of a marker in the captured image.
(Appendix 22) The control method of Appendix 19, wherein the object recognition region is predetermined.
(Appendix 23) The control method of Appendix 19 further comprising:

controlling the display device to display the operation screen when the marker is included in the captured image, and

controlling the display device not to display the operation screen when the marker is not included in the captured image.

(Appendix 24) The control method of Appendix 23 further comprising controlling the display to display the operation screen at a position determined on the basis of a position of the marker that is included in the captured image.
(Appendix 25) The control method of Appendix 21,

wherein the marker is an image that is displayed on a display unit of a device worn by the user.

(Appendix 26) The control method of Appendix 19 further comprising transmitting the operation screen or the captured image on which the operation screen is superimposed through a communication line.
(Appendix 27) The control method of Appendix 19,

wherein the computer is further coupled with a sensor that is worn by a user of the computer,

wherein the method further comprising:

detecting a position of the operation body in the captured image at a timing determined by a detection result of the sensor or detect a movement of the operation body in the captured image at a period including the timing; and

recognizing an input operation on the basis of the detected position or movement.

(Appendix 28) A non-transitory computer-readable storage medium storing a program that causes a computer, which is to be coupled with a display device, to:

extract a partial region of a captured image as an object recognition region;

recognize an object in the object recognition region;

acquire object information regarding the recognized object;

control the display device to display an operation screen and the acquired object information;

recognize an operation body in the captured image; and

recognize an input operation with respect to the operation screen on the basis of at least one of a position and a movement of the operation body.

(Appendix 29) The non-transitory computer-readable storage medium of Appendix 28,

wherein the object is recognized by performing at least one of:

extracting an image of the object from the captured image; or

reading an identifier of the object from a symbol that is attached to the object.

(Appendix 30) The non-transitory computer-readable storage medium of Appendix 28, wherein the object recognition region is determined based on a position of a marker in the captured image.
(Appendix 31) The non-transitory computer-readable storage medium of Appendix 28, wherein the object recognition region is predetermined.
(Appendix 32) The non-transitory computer-readable storage medium of Appendix 28,

wherein the program further causes the computer to:

control the display device to display the operation screen when the marker is included in the captured image, and

not control the display device to display the operation screen when the marker is not included in the captured image.

(Appendix 33) The non-transitory computer-readable storage medium of Appendix 32,

wherein the program further causes the computer to control the display to display the operation screen at a position determined on the basis of a position of the marker that is included in the captured image.

(Appendix 34) The non-transitory computer-readable storage medium of Appendix 30,

wherein the marker is an image that is displayed on a display unit of a device worn by the user.

(Appendix 35) The non-transitory computer-readable storage medium of Appendix 28,

wherein the program further causes the computer to transmit the operation screen or the captured image on which the operation screen is superimposed through a communication line.

(Appendix 36) The non-transitory computer-readable storage medium of Appendix 28,

wherein the computer is further coupled with a sensor that is worn by a user of the computer,

wherein the program further causes the computer to:

detect a position of the operation body in the captured image at a timing determined by a detection result of the sensor or detect a movement of the operation body in the captured image at a period including the timing; and

recognize an input operation on the basis of the detected position or movement.

The application is based on Japanese Patent Application No. 2016-042263 filed on Mar. 4, 2016, the content of which is incorporated herein by reference.

It is apparent that the present invention is not limited to the above embodiment, and may be modified and changed without departing from the scope and spirit of the invention.

What is claimed is:

1. An information processing apparatus to be coupled with a display device, the apparatus comprising a hardware processor configured to:
extract a partial region of a captured image as an object recognition region;
recognize an object in the object recognition region;
acquire object information regarding the recognized object;
control the display device to display an operation screen and the acquired object information;
recognize an operation body in the captured image; and
recognize an input operation with respect to the operation screen on the basis of at least one of a position and a movement of the operation body.

2. The information processing apparatus of claim 1,
wherein the hardware processor further configured to recognize the object by at least one of:
extracting an image of the object from the captured image; or
reading an identifier of the object from a symbol that is attached to the object.

3. The information processing apparatus of claim 1,
wherein the object recognition region is determined based on a position of a marker in the captured image.

4. The information processing apparatus of claim 1,
wherein the object recognition region is predetermined.

5. The information processing apparatus of claim 1,
wherein the hardware processor is further configured to control the display device to display the operation screen when the marker is included in the captured image, and
wherein the hardware processor is further configured not to control the display device to display the operation screen when the marker is not included in the captured image.

6. The information processing apparatus of claim 5,
wherein the hardware processor is further configured to control the display to display the operation screen at a position determined on the basis of a position of the marker that is included in the captured image.

7. The information processing apparatus of claim 3,
wherein the marker is an image that is displayed on a display unit of a device worn by the user.

8. The information processing apparatus of claim 1,
wherein the hardware processor is further configured to transmit the operation screen or the captured image on which the operation screen is superimposed through a communication line.

9. The information processing apparatus of claim 1 to be further coupled with a sensor that is worn by a user of the apparatus,
wherein the hardware processor is further configured to:
detect a position of the operation body in the captured image at a timing determined by a detection result of the sensor or detect a movement of the operation body in the captured image at a period including the timing; and
recognize an input operation on the basis of the detected position or movement.

10. A control method to be executed by a computer to be coupled with a display device, the method comprising:
extracting a partial region of a captured image as an object recognition region;
recognizing an object in the object recognition region;
acquiring object information regarding the recognized object;
controlling the display device to display an operation screen and the acquired object information;
recognizing an operation body in the captured image; and
recognizing an input operation with respect to the operation screen on the basis of at least one of a position and a movement of the operation body.

11. A non-transitory computer-readable storage medium storing a program that causes a computer, which is to be coupled with a display device, to:
extract a partial region of a captured image as an object recognition region;
recognize an object in the object recognition region;
acquire object information regarding the recognized object;
control the display device to display an operation screen and the acquired object information;
recognize an operation body in the captured image; and
recognize an input operation with respect to the operation screen on the basis of at least one of a position and a movement of the operation body.
